(19) United States
(12) Patent Application Publication
(10) Pub. No.: US 2004/0233159 A1
(43) Pub. Date: Nov. 25, 2004

(54) Operating device for controlling functions in electronic equipment

(76) Inventor: Ziad Badarneh, Oslo (NO)

Correspondence Address: RODMAN RODMAN, 7 SOUTH BROADWAY, WHITE PLAINS, NY, 10601

(21) Appl. No.: 10/487,807

(22) PCT Filed: Sep. 3, 2002
(86) PCT No.: PCT/NO02/00309

(30) Foreign Application Priority Data
Sep. 4, 2001 (NO) 20014305
Mar. 1, 2002 (NO) 20021056

(51) Int. Cl. G09G 5/00

(52) U.S. Cl. 345/156

(57) ABSTRACT

An operating device for controlling user functions in electronic user equipment in interaction with a display screen, and/or for controlling a means of transport, e.g., a motor vehicle, boat, ship, aircraft or the like, where the operating device has a control element having four tilting positions and central depression, with movement on rotation or sliding in at least two directions, where there is a means for force feedback, wherein the movement is actuated by an electromotor or step motor for initiating or simulating a “step feeling”, and wherein the angular extent of the movement, or the slide extent of the movement, and speed of the movement are measured, and where the “step feeling” will be able to vary in frequency because of the extent of movement. The motor is designed to perform operations selected from the group: controlling the number of steps, controlling the distance between steps, controlling the force a user needs to apply, braking or stopping movement of the control element, causing a back or return movement, stimulating or oscillating (small reciprocating motions), detecting movement and direction of movement.

The present invention relates to an operating device as disclosed in the preambles of the attached independent claims.

This application describes new solutions and combinations in relation to operating devices or so-called multifunction switches for use in connection with electronic apparatus which preferably have a display, and control of means of transport and functional equipment with or without the assistance of electronic technology or means of display. The invention is related, inter alia, to a technique that is often referred to as force feedback in order to be able to simulate movements or give feedback in the form of pulses for executed operations in connection with the use of multifunction switches, or optionally in association with a touch screen.

The background for the invention is, inter alia, the desire for improved and easier operation of electronic equipment and to have a minimum number of switches to deal with. Thus, the object of the invention is the provision of operating devices which will be particularly suitable for use in equipment which has or is used in connection with a display screen, such as various handheld or fixed apparatus, for example, telephones, mobile telephones, PDAs, mini-computers (PCs), multi-communicators, photographic and foil equipment, radios, access and control equipment, calculators, program testing and analysis equipment, music centres, and remote control for all types of apparatus and functions. It is precisely with these apparatus that simple, readily understandable functionality in connection with the operating devices is a major object of the present invention.

It is common knowledge that small and also portable apparatus are developing rapidly, and therefore many typical product groups have started to adopt techniques from one another by combining several applications in one and the same apparatus. A typical example of this are known as multi-communicators or smart phones, which are a combination of a mobile telephone, a PDA, a PC and a camera. All these types of apparatus make use of a display screen with the aid of which it is possible to control the apparatus, but in today's situation this involves the use of an increasing number of so-called press switches.

The Applicant's earlier international patent applications, PCT/NO96/00282, PCT/NO99/00373, PCT/NO00/00372, and PCT/NO01/00057 describe specific switch solutions, parts of PCT/NO01/00056 relate to an interactive system adapted to electronic equipment and interactive use of different types of multifunction switches for electronic apparatus such as those in a vehicle. The first-mentioned four patent applications teach, inter alia, that by means of a so-called toggle function, the switch can be moved in different directions without remaining in the fixed positions, but rather returning to a starting point.

One of the objects in connection with the present invention is to provide a number of switch solutions that can replace traditional push-button keyboards. Some of these solutions are also taught in the aforementioned earlier applications. In some cases, the pressure-operated switches disclosed in these earlier applications have physical feedback when in use in that steps in the rotation movement move springs which a user will feel via the control element or switch button of the switch during use. However, the present invention will allow the step movement to be simulated and given a characteristic, customised “user profile”.

The solutions described according to the present invention represent to a certain extent a further development of these previously described solutions and provide some concrete examples of the use of the inventor's multi function switches, e.g., for use in a car.

International Application PCT/NO01/00056 teaches the use of multifunction switches mounted, for instance, on a steering wheel. The combination of a movable multifunction switch and interactive display functions is also illustrated and described. The application focuses in particular on a multifunction switch having three pressing functions, and the combination of two multifunction switches. A sliding switch with four pressure positions is also shown.

The technical solutions of rotating multifunction switches will be taught further in connection with the present invention. It will also be shown how the invention allows advanced, but easily operatable multifunction switches to be made and used, for example in a force feedback system. This represents a significant aspect of the applications of multifunction switches, with a view to allowing a user to have finger-perceptible feedback from a system of which the multifunction switch is an integral part and associated with the movement of the control element on a multifunction switch of this kind.

In connection with so-called force feedback with pulses, reference will be made to U.S. Pat. Nos. 5643087, 5742278 and 6036495 in order to illustrate some of the prior art. In the case of a so-called joystick, electric motors are used which give feedback to a movement of the joystick handle. These motors are usually connected directly to the handle and can control or actuate the movement in an X/Y direction.

The present invention will focus on, inter alia, the structure of a roller switch for force feedback, and rotatable switches having five pressure points, and centre point deviation control also for force feedback. Another object of the present invention is to allow the manufacture of switches which give physical feedback to a user without the control element on the switch itself (operating device) having to move to any appreciable extent. The starting point in this case consists of solutions which can simulate movements that the earlier solutions have had.

The multifunction switches and switch combinations used are not intended to have fixed marking, as for instance by using silk screen printing. All the information the user needs is intended to be shown on a display means. In other words, the intention is that the multifunction switch should be able to operate interactively with a menu system shown on a display screen, for example, a LCD screen.

In electronic apparatus, the multifunction switches could replace the traditional keyboard or keypad, or be a supplementary element, for example, for navigation. The user will then be able to operate the apparatus and its functions by rotating or sliding and pressing the multifunction switch in interaction with what is shown on the screen. It will be easy to see the advantage of using such a multifunction switch mounted in a remote control unit in connection with the use of TVs, projectors and the like.

In the case of vehicle, the multifunction switches can be mounted on the steering wheel, control lever, centre console, sides panels, doors and the like, or function together with a handheld apparatus such as a remote control unit. The display component in a vehicle can, for example, be located in connection with the dashboard in a car, or in proximity thereto, so that the driver can easily see the display whilst driving, but without the driver thereby being distracted from constantly assessing the traffic. Of course, in another variant the information could be projected onto the windscreen, as is known from fighter planes, for instance. For use by persons other than the driver of the vehicle, it is conceivable to place a display in a centre console in the front of the car, or immediately in front of a passenger. An alternative location here could be in the back of a front seat for back seat passengers, or in the roof, then optionally as a folding solution.

Another object of the present invention is to describe and show in some detail the structure and the function of the multifunction switches associated with a technique often referred to as force feedback, abbreviated to FF, to be able to simulate movements or give feedback in the form of pulses for executed operations in connection with the use of multifunction switches.

In summary, the invention therefore relates to the function and structure of, inter alia, rotary multifunctional switches having three to five depression positions for use in handheld or fixed electronic apparatus and/or means of transport which have or are connected to display elements for function control.

In addition and as indicated, the present invention will also relate to a number of switch solutions which represent major further developments of the solutions previously described by the Applicant.

The following figures will describe the general idea of the use of multifunction switches, and in particular applications that would be useful in connection with their use in vehicles.

However, any person of ordinary skill in the art will understand that the solutions illustrated and described can be used in all forms of electronic equipment connected to display functions.

The invention will now be described in more detail in connection with non-limiting exemplary embodiments of the invention shown in the figures.

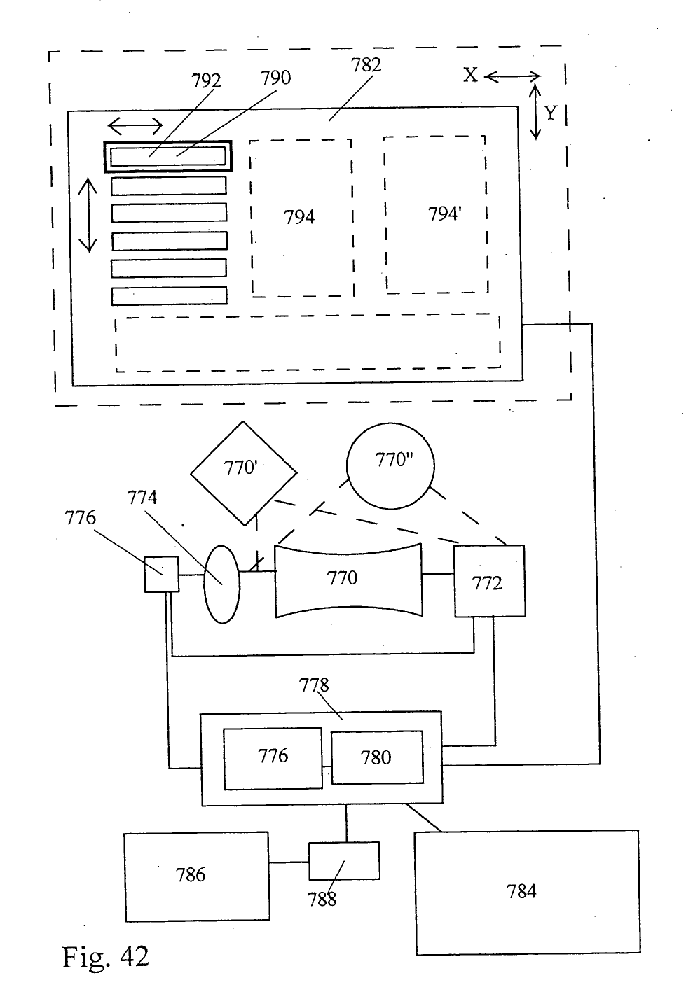

The switch devices shown are referred to as “operating device” or “multifunction switch”. These are intended for the control of user functions in electronic user equipment in interaction with a display screen. The interaction will be better understood in connection with the discussion of FIG. 42

The characteristic features of the invention are set forth in the characterising clauses of the aforementioned independent operating device claims and the subsidiary claims that are linked to each of these said independent claims.

The invention will now be described in more detail with reference to the attached figures which show various embodiments of the invention.

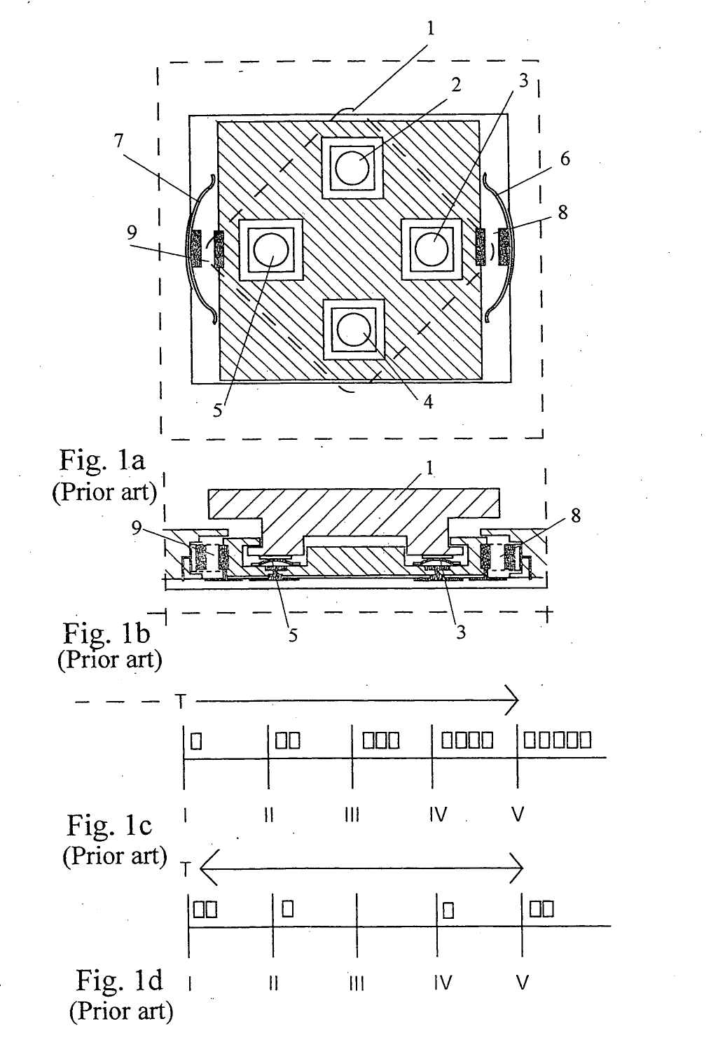

FIGS. 1a-d show a solution known from International Application PCT/NO01/00057.

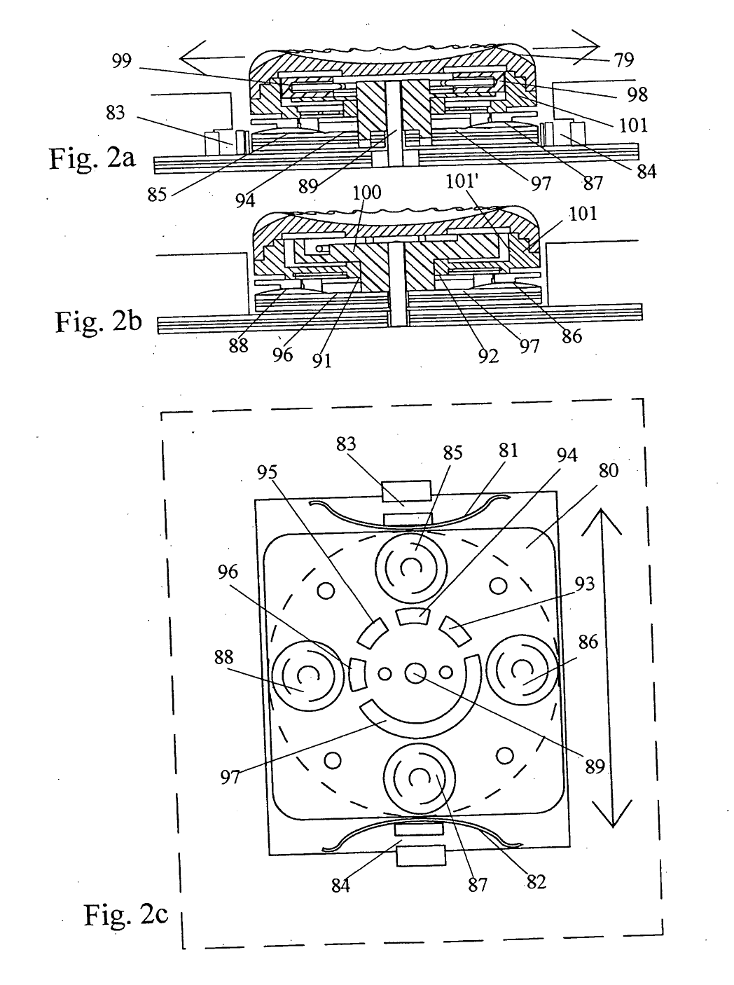

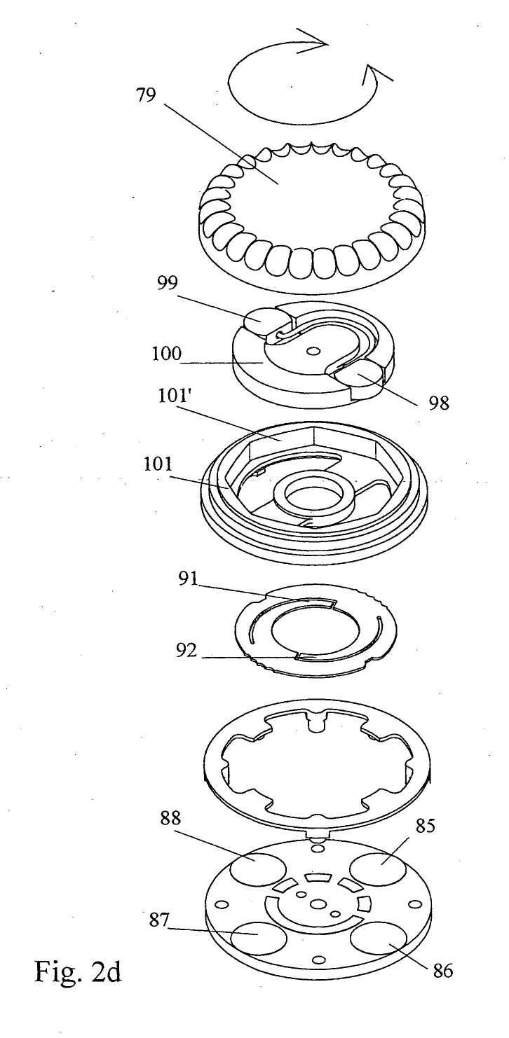

FIGS. 2a-2c show a rotary pressure switch with pulse generator for two-way movement, whilst FIG. 2d is an exploded view of this switch.

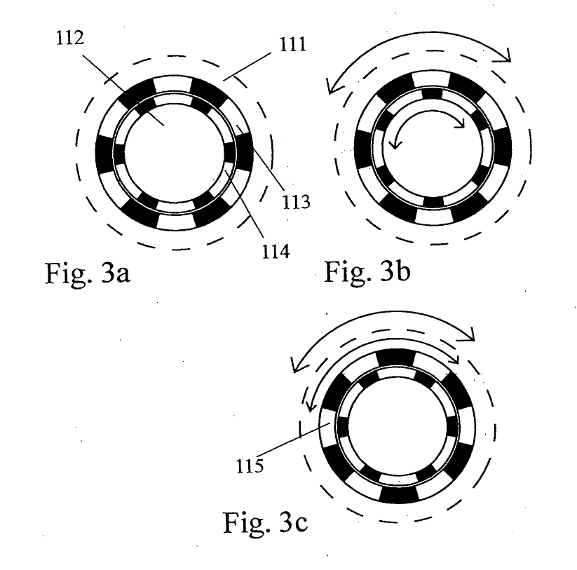

FIGS. 3a-3c show the use of magnets or electromagnets in connection with a rotary switch.

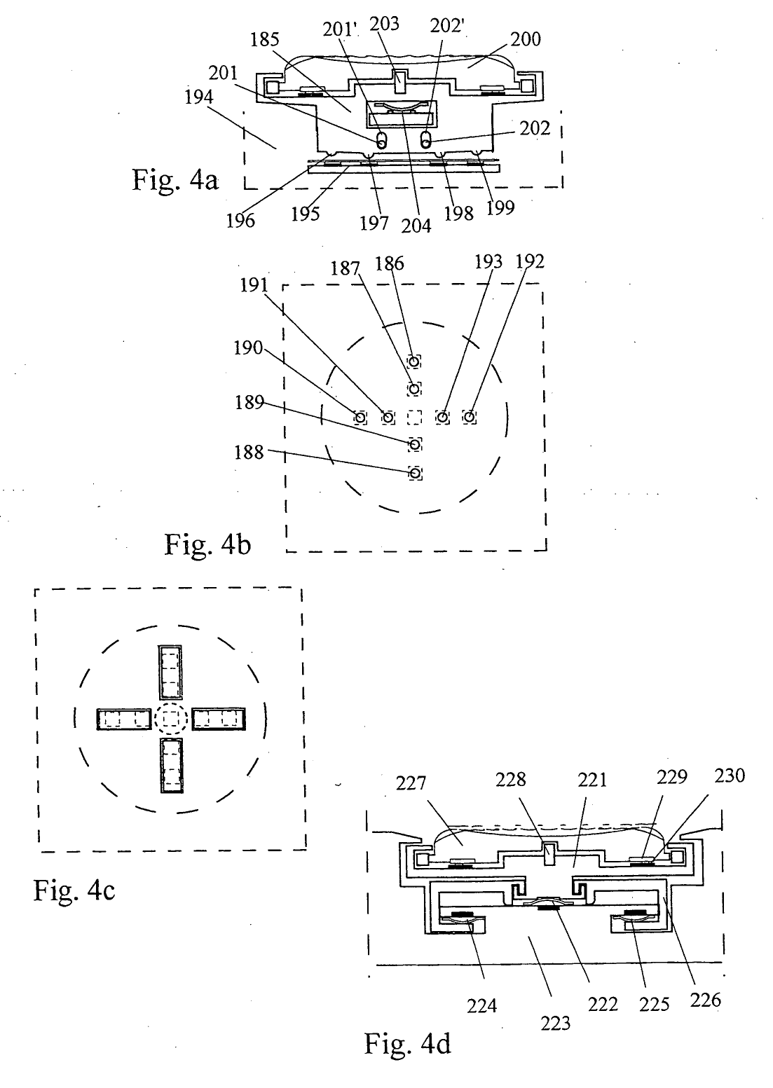

FIGS. 4a-4d show a modification of the rotary solution.

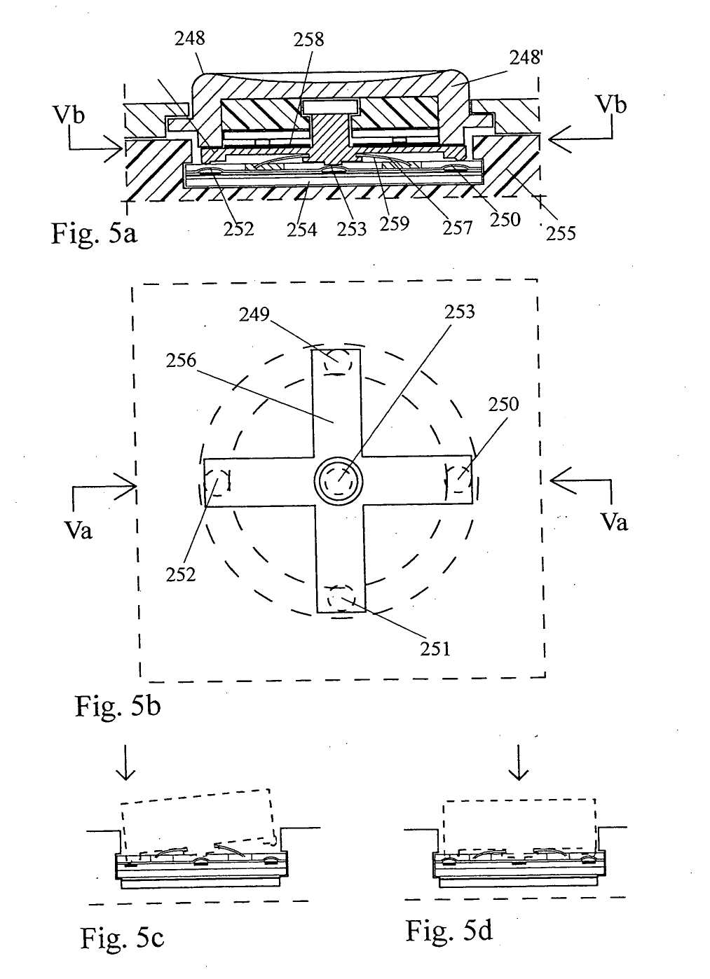

FIGS. 5a-5d show a rotary switch with five pressure points.

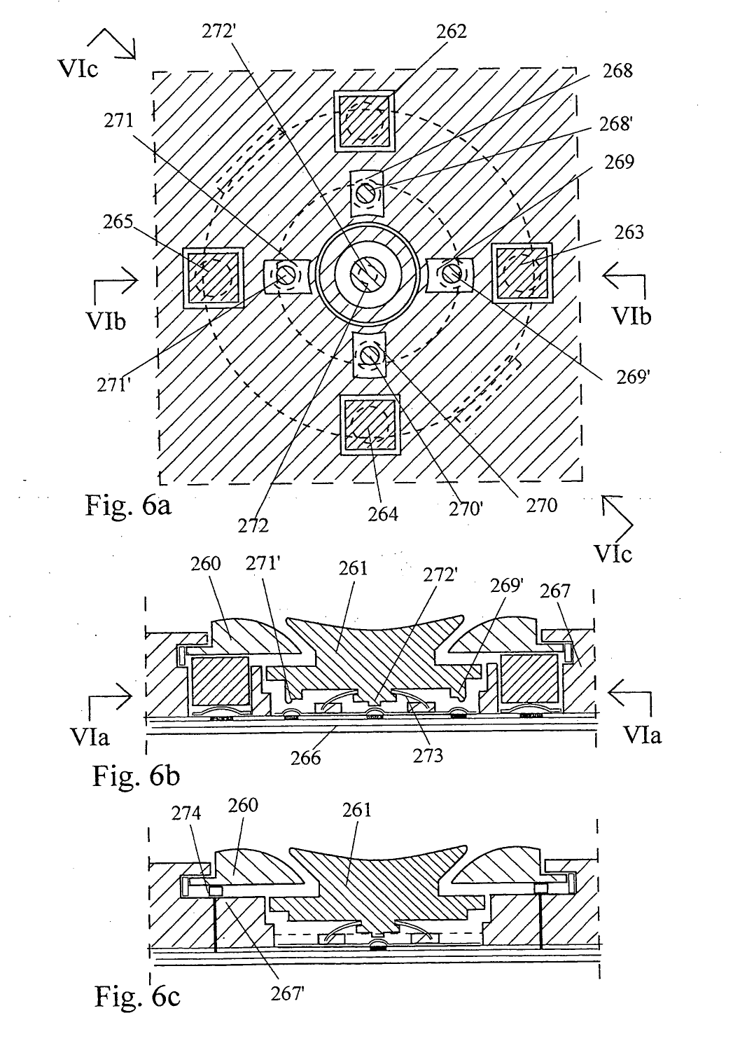

FIGS. 6a-c show a rotary switch with a fixed centre portion which has five pressure points and an outer part with four pressure points.

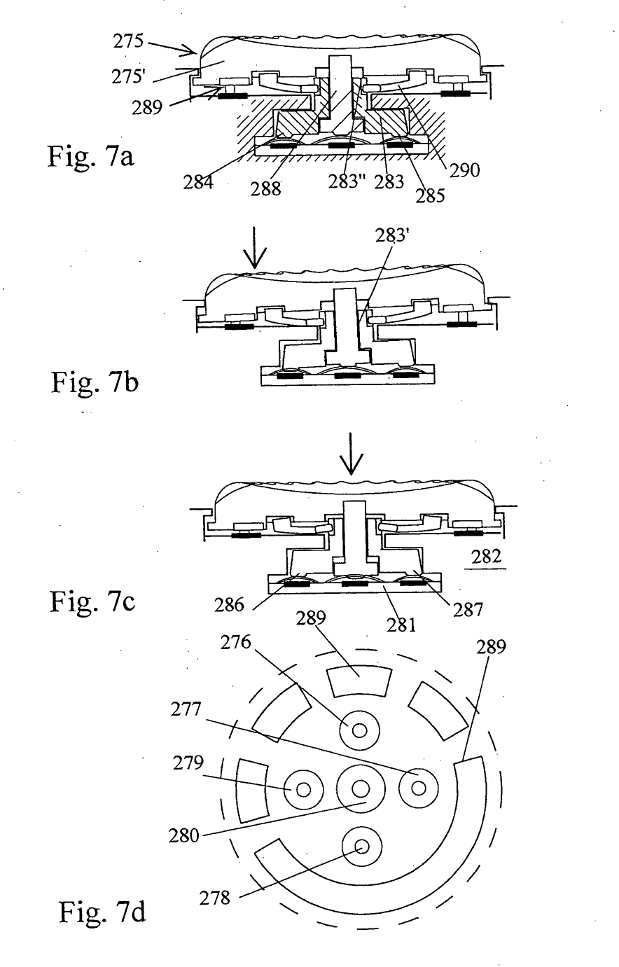

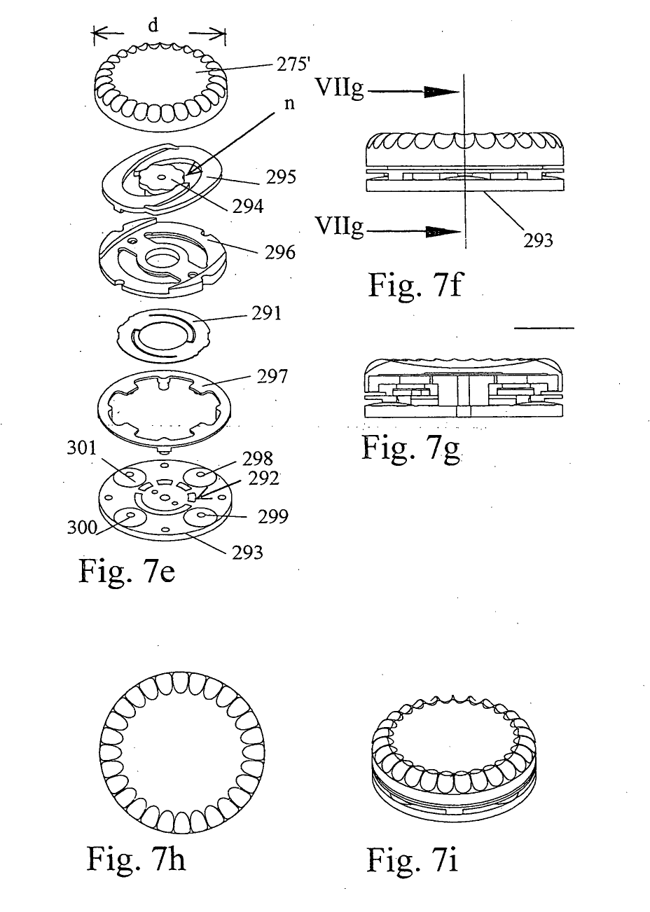

FIGS. 7a-7d show a rotary switch with five pressure points, whilst the version shown in FIGS. 7e-7i is the rotary switch made having four pressure points, and where FIG. 7e is an exploded view of the switch.

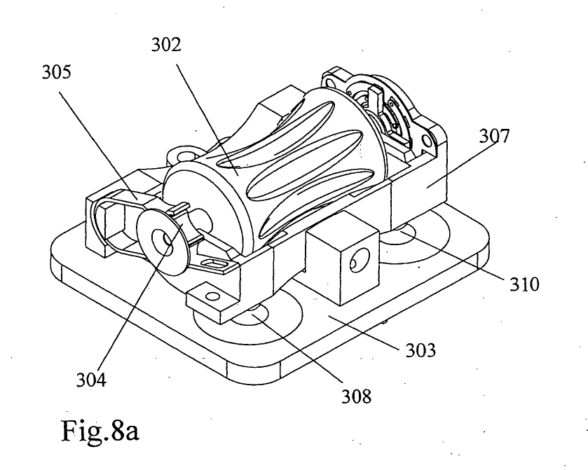

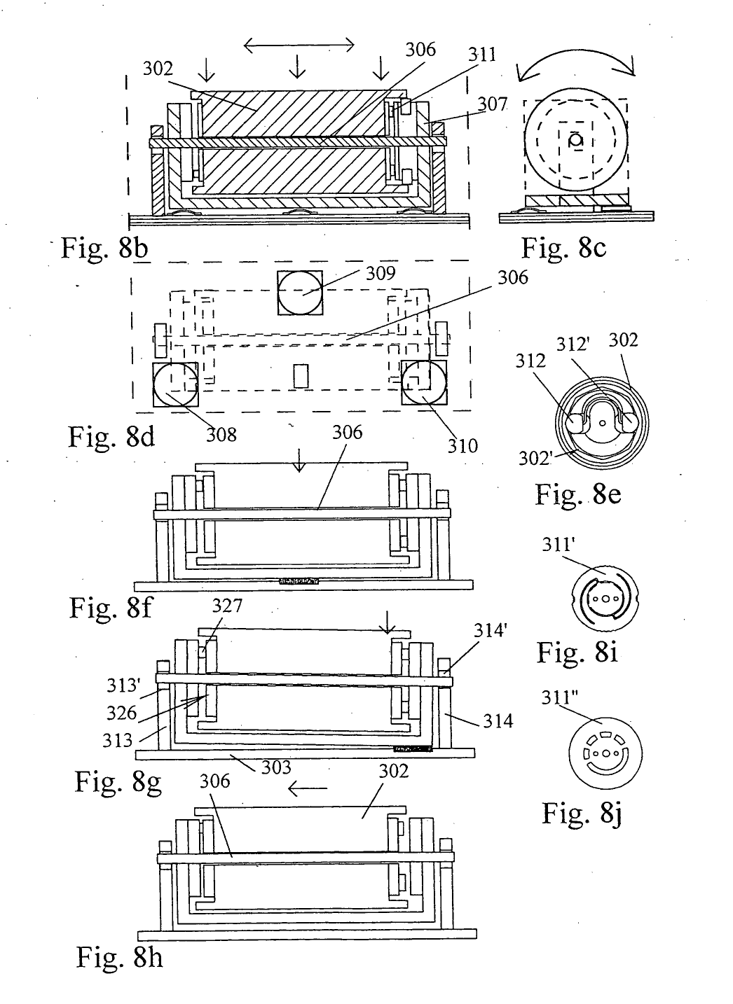

FIG. 8a is a perspective view of a roller switch equipped with three pressure points; FIGS. 8b-8j show more details of this switch and its three pressure points.

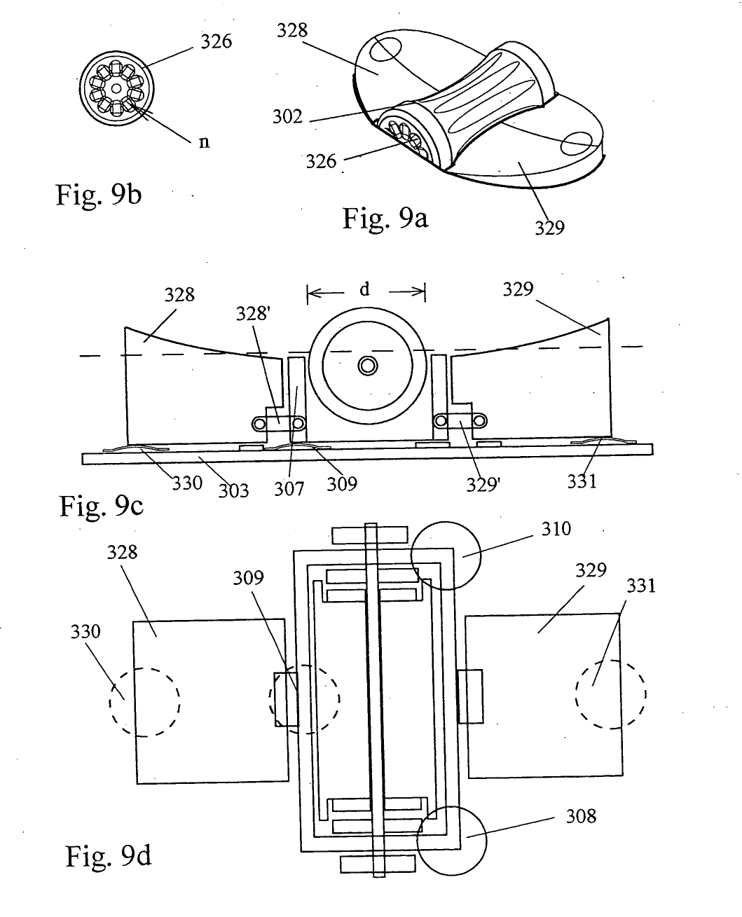

FIGS. 9a-d show a cylinder switch with pressure switches mounted.

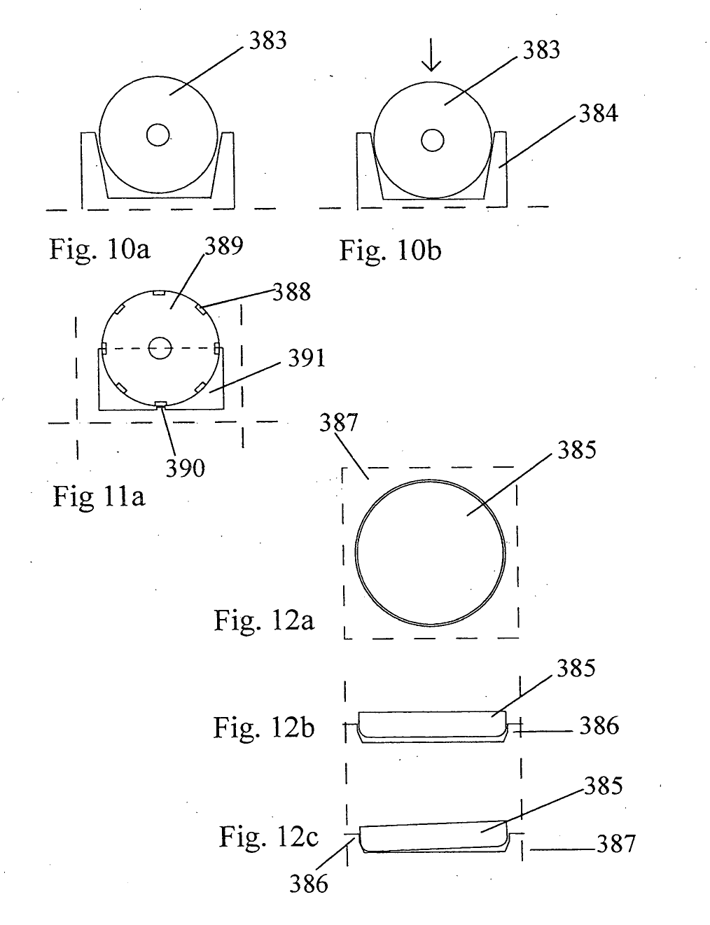

FIGS. 10a and 10b show an embodiment where a control element in the form of a roller is immobilised when depressed for prevention of rotation.

FIG. 11 shows a roller switch with physical means for stopping rotation on depression.

FIGS. 12a-12c show a clamp solution according to the principle shown in FIG. 10 for a horizontal rotary switch.

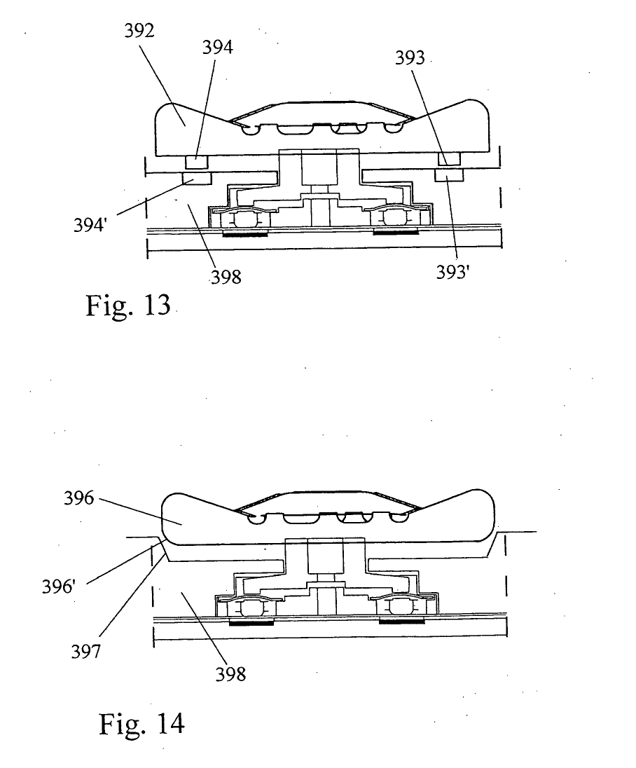

FIG. 13 shows a sliding switch that is lockable on depression. FIG. 14 shows a sliding switch whose control element is prevented from being moved on depression.

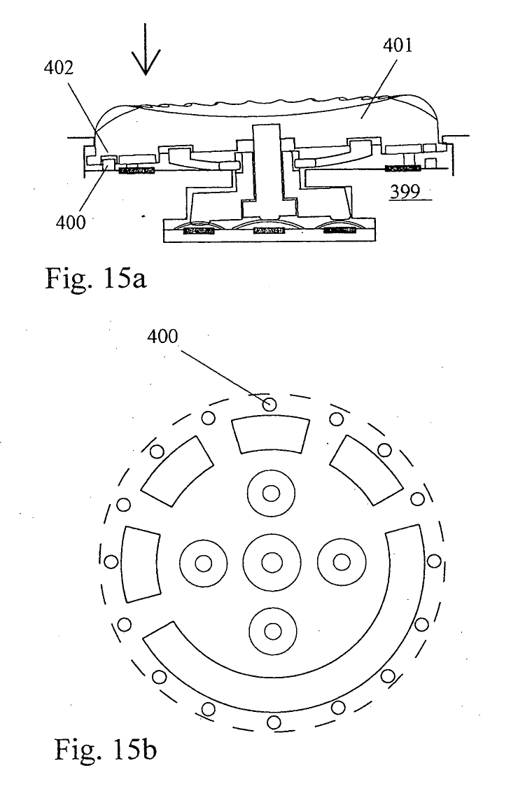

FIGS. 15a-15b show a horizontally arranged rotary switch which on depression is locked against further rotation.

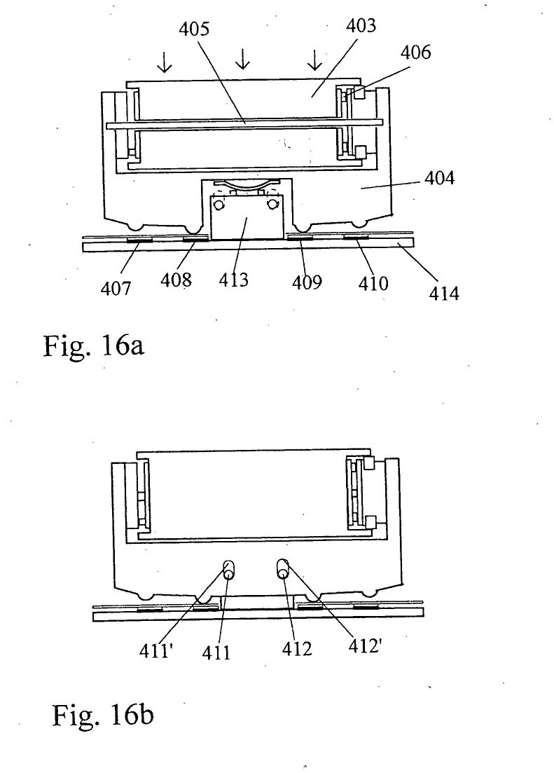

FIG. 16a and FIG. 16b show a variant of the solution shown in FIG. 11, but equipped with a roller-shaped control element.

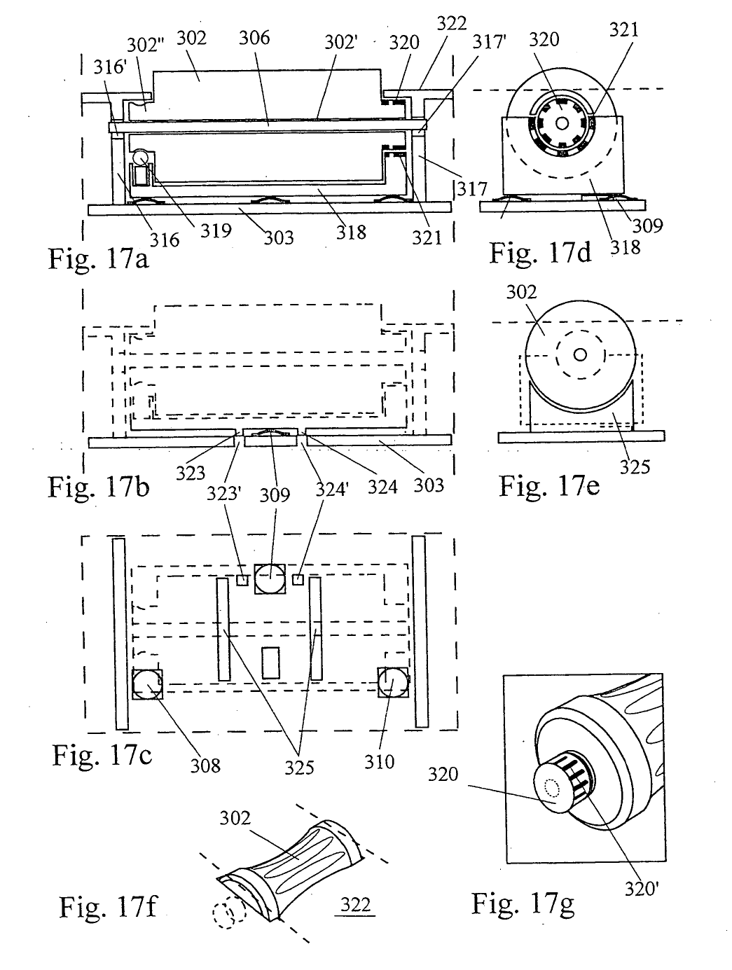

FIGS. 17a-17g show a variant of a roller switch.

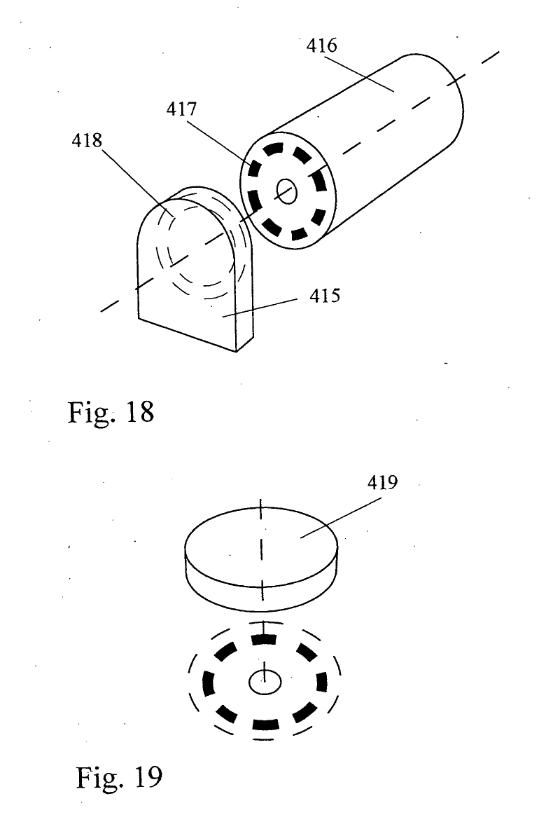

FIG. 18 shows a roller switch designed for force feedback.

FIG. 19 shows a variant of the solution shown in FIG. 18, but with a horizontal, rotatable control element.

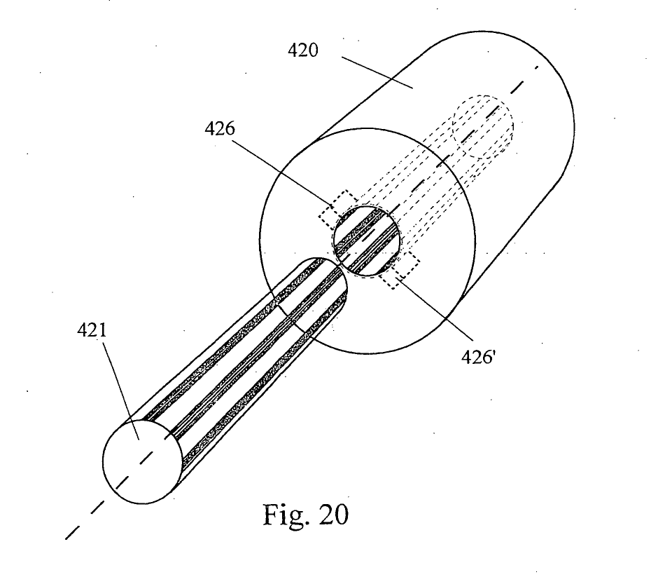

FIG. 20 shows the principle for a roller switch with force feedback.

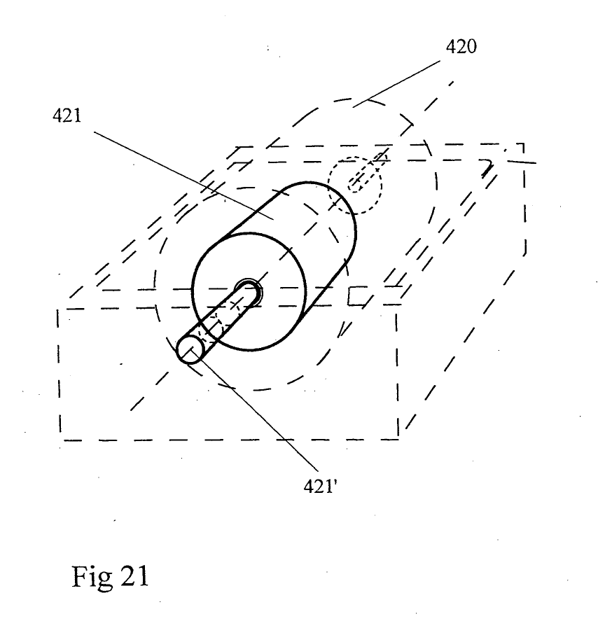

FIG. 21 shows a second roller switch where an electromotor is used.

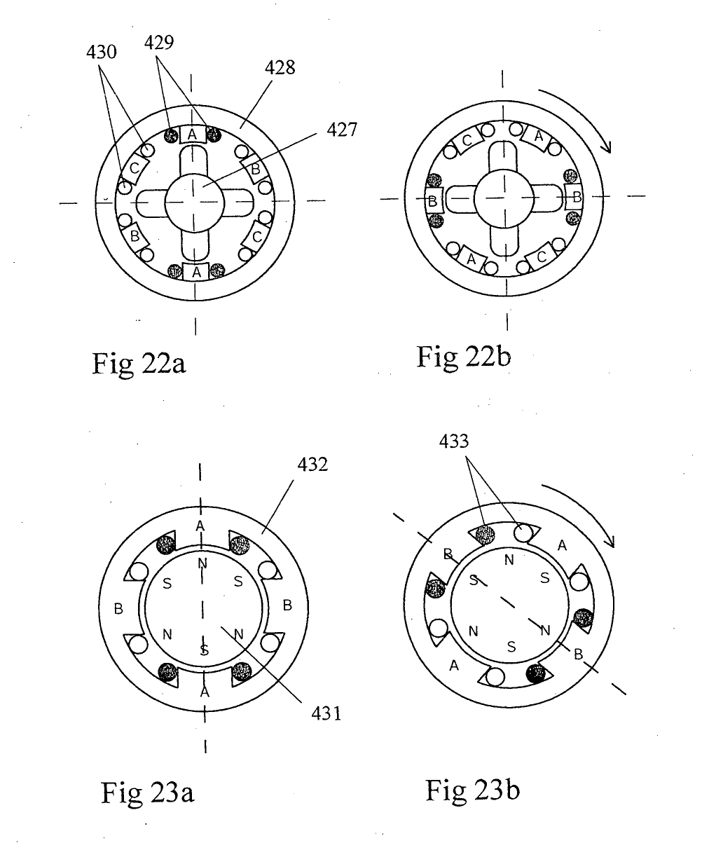

FIGS. 22a and 22b, and FIGS. 23a and 23b, show a principle, known per se, in connection with a step motor.

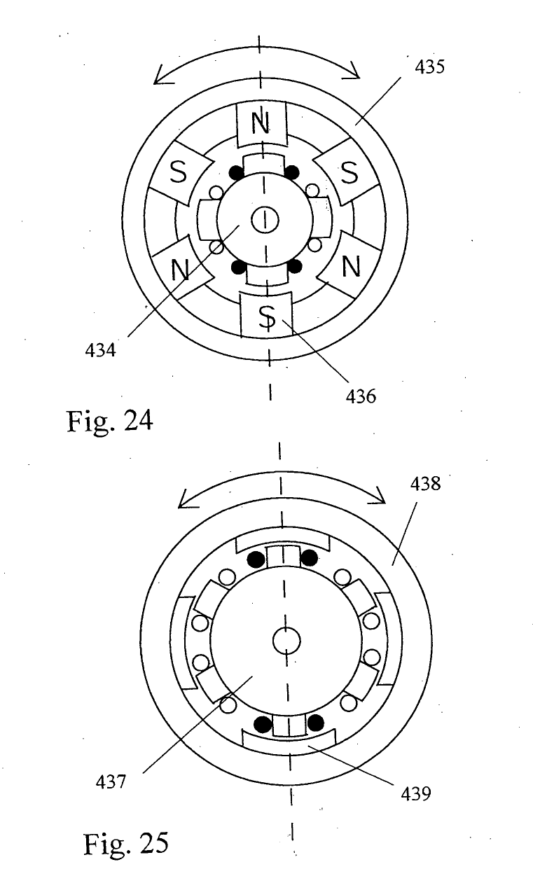

FIG. 24 and FIG. 25 show variants of the solution shown in FIGS. 22 and 23.

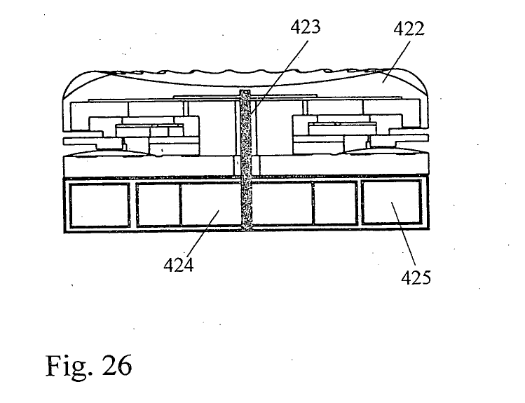

FIG. 26 shows in principle a practical embodiment of an operating device in connection with the use of the properties of a step motor.

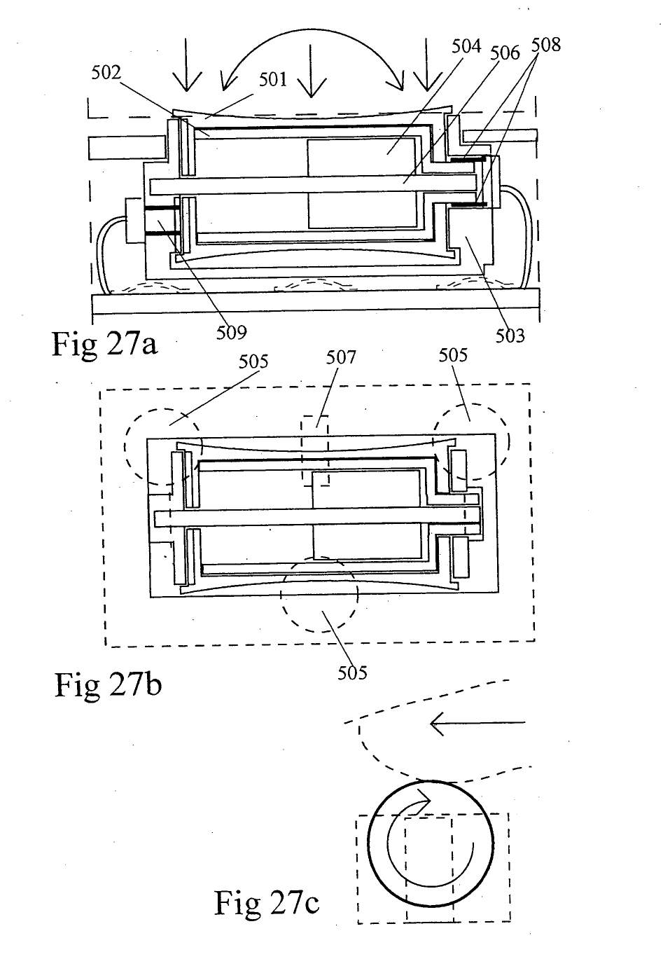

FIGS. 27a-c show a three pressure point roller switch with a built-in electromotor or step motor.

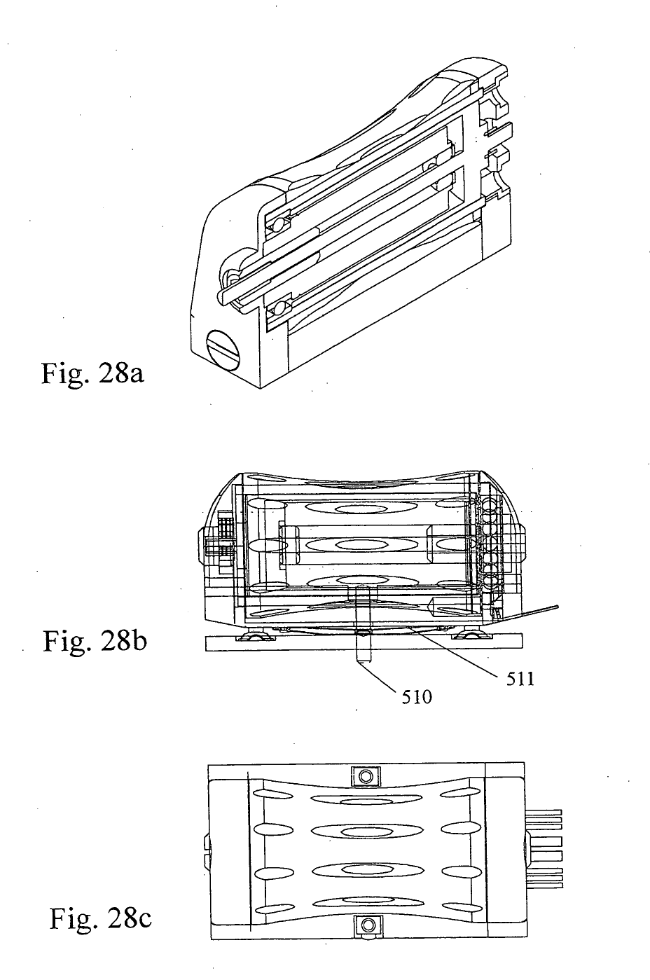

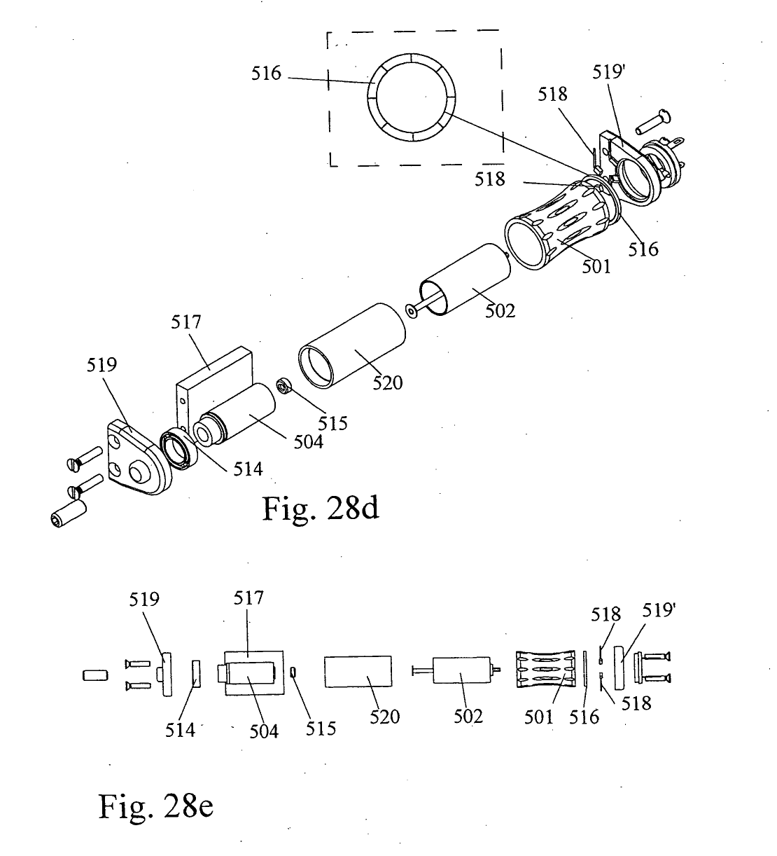

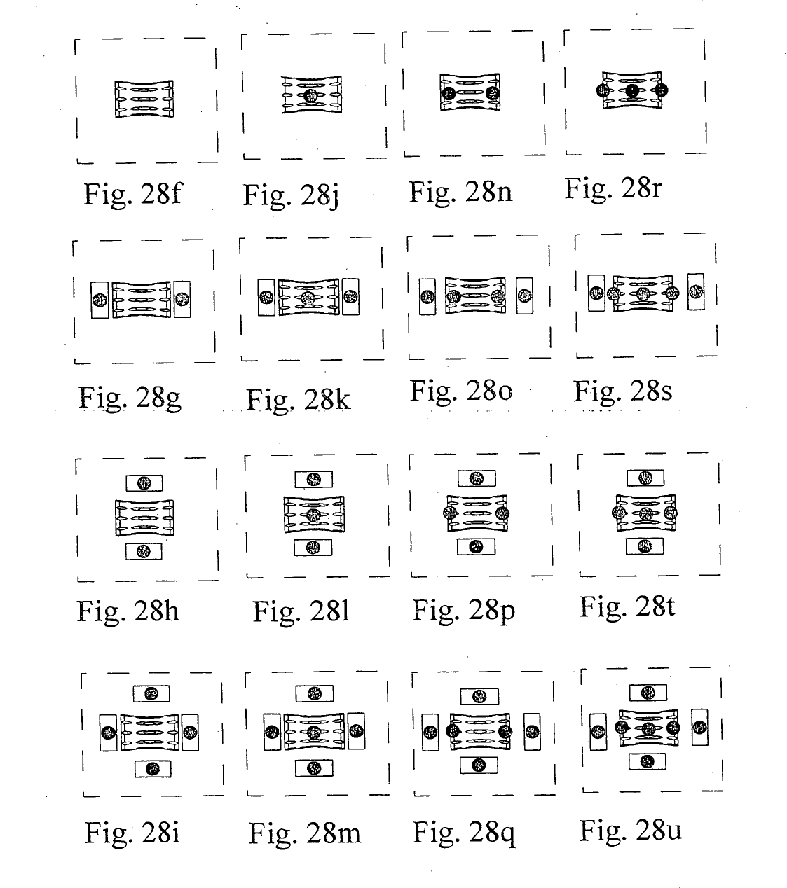

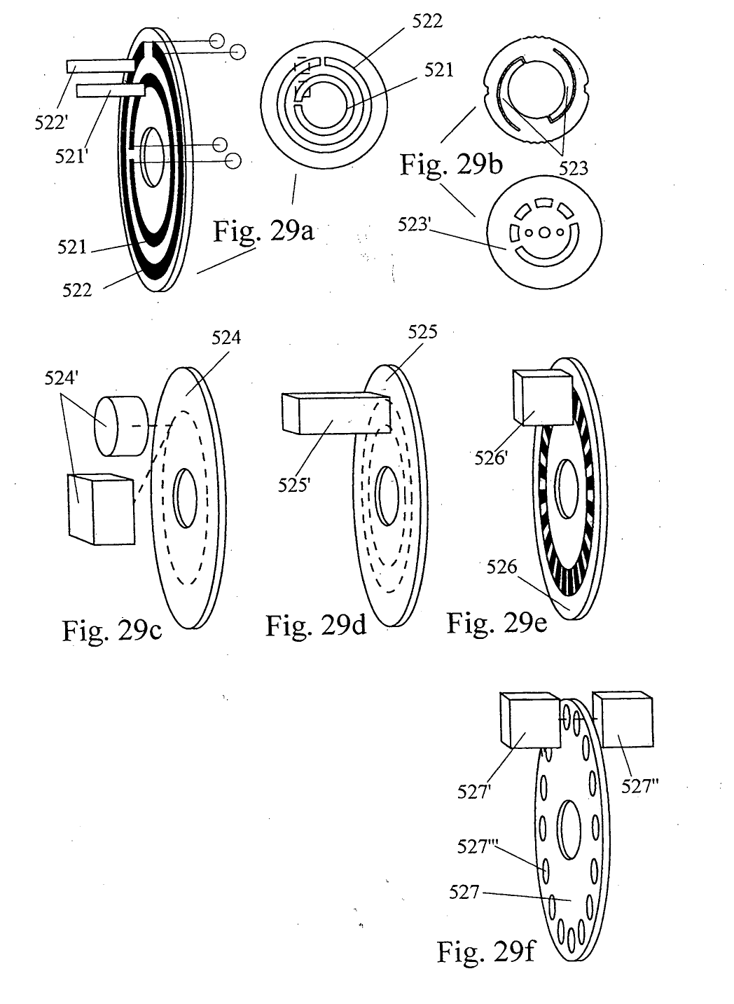

FIGS. 28a-e show a roller switch in which an electromotor is incorporated, and FIGS. 28f-u show variants thereof.

FIGS. 29a-f show alternative principles for detection of rotation.

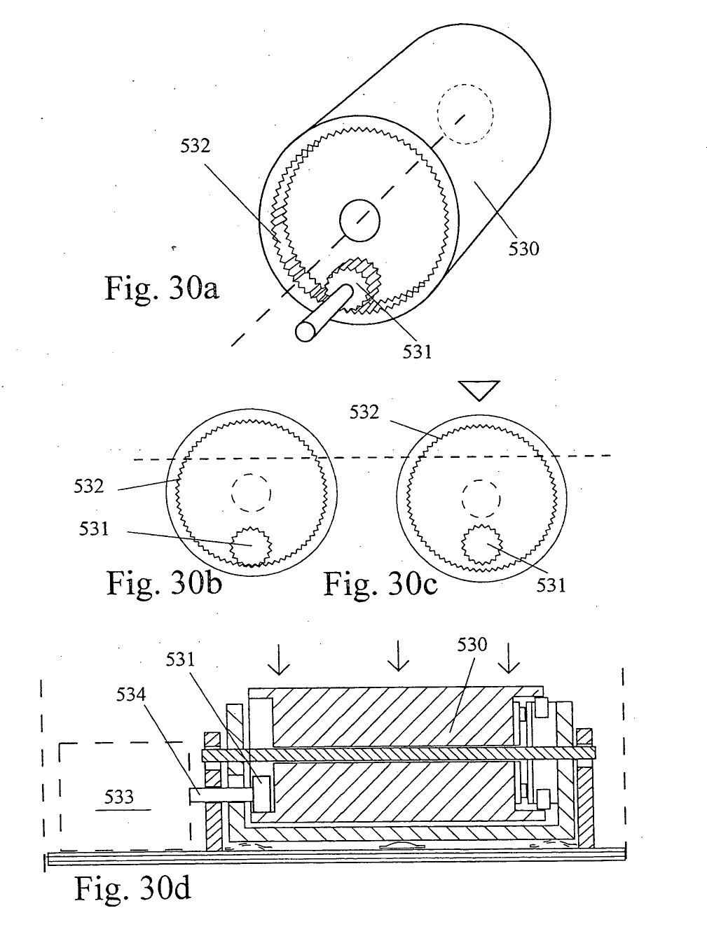

FIGS. 30a-33b show transmission of force to a roller switch.

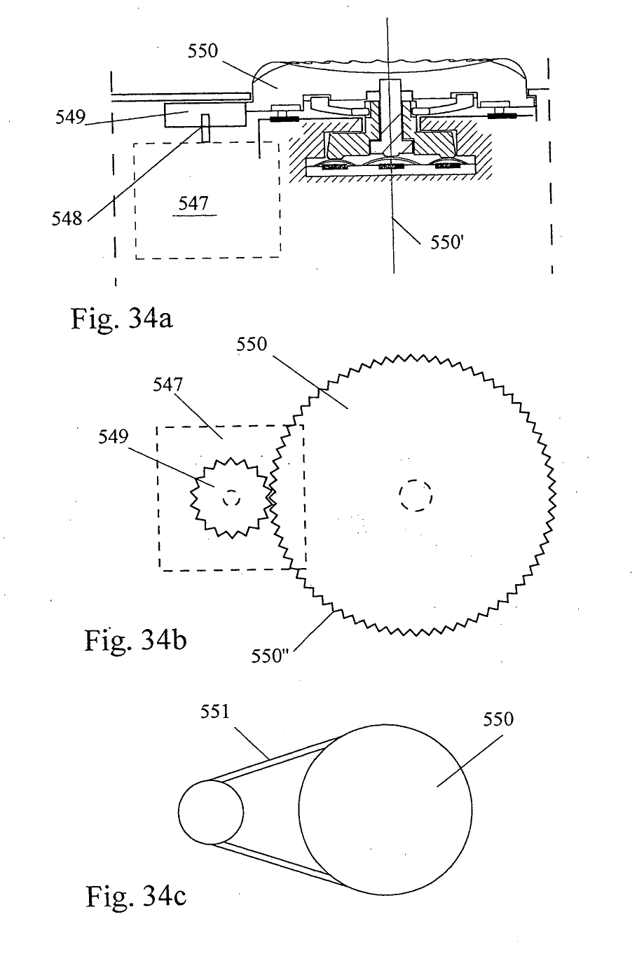

FIGS. 34a-c show delivery of force for a five pressure point rotary switch.

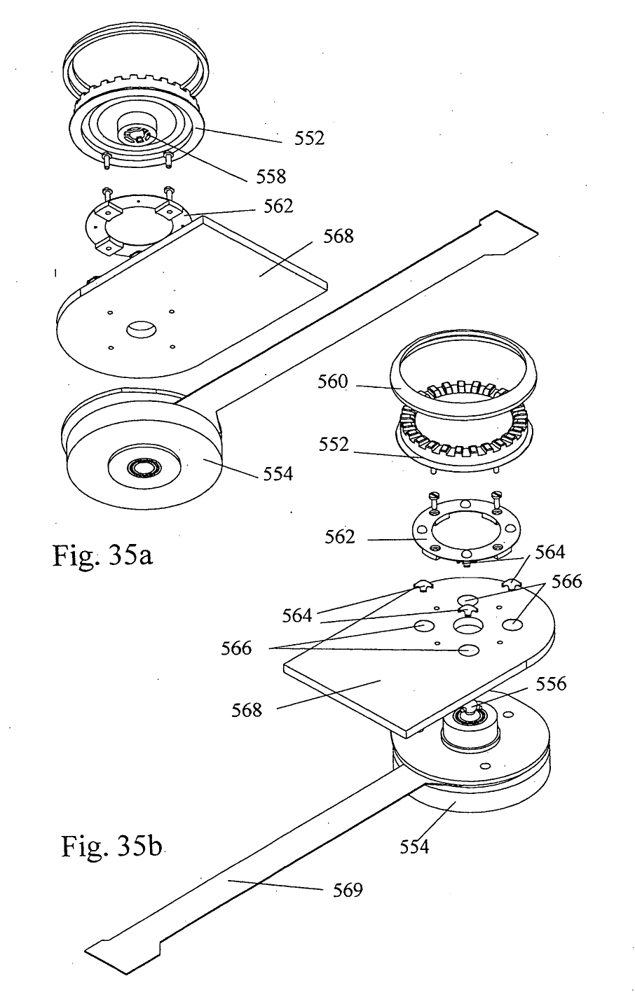

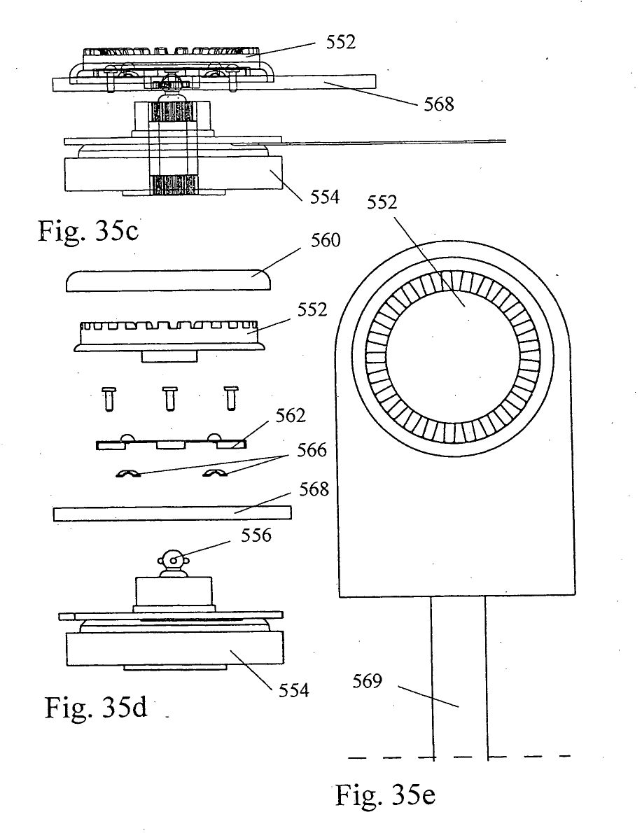

FIGS. 35a-e show a four pressure point rotary switch with direct axial force connection.

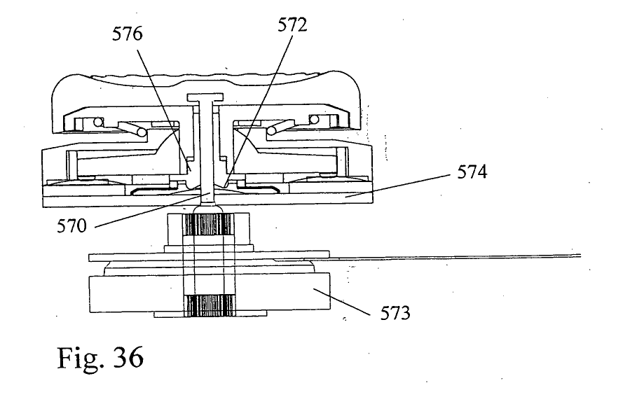

FIG. 36 shows a five pressure point rotary switch as shown in FIG. 4 with axial motor.

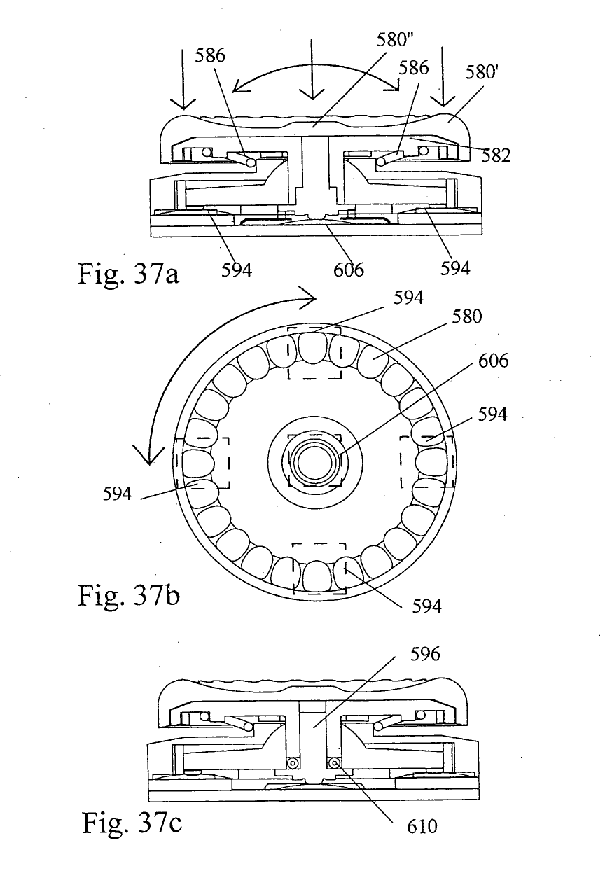

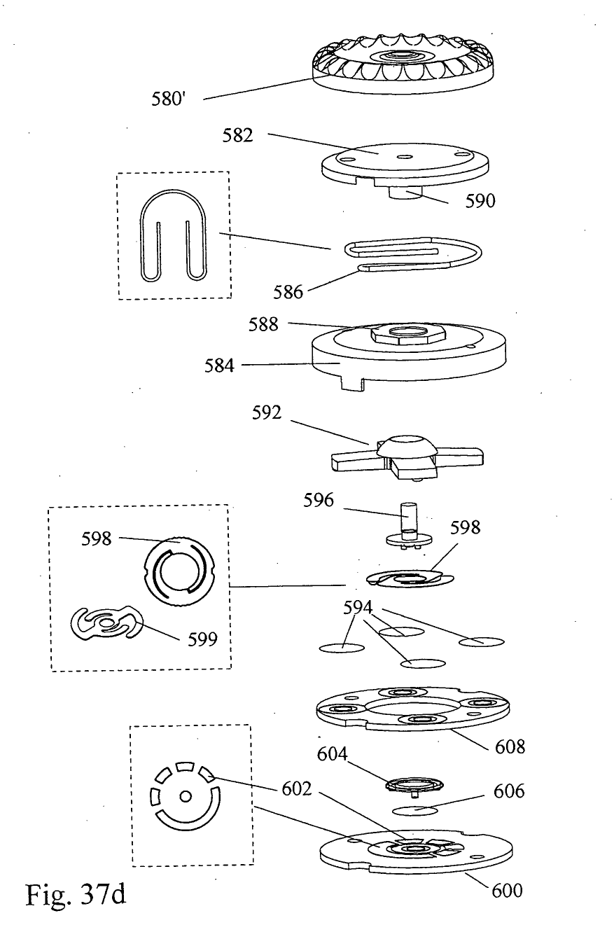

FIGS. 37a-d show a five pressure point rotary switch.

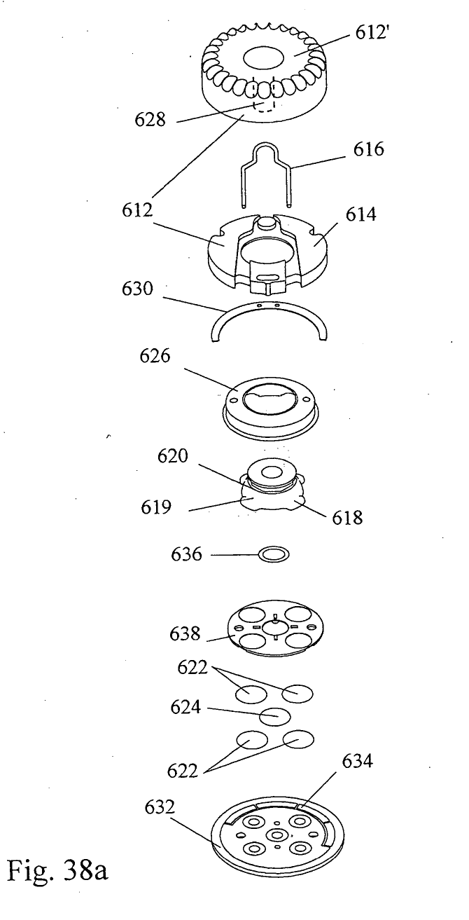

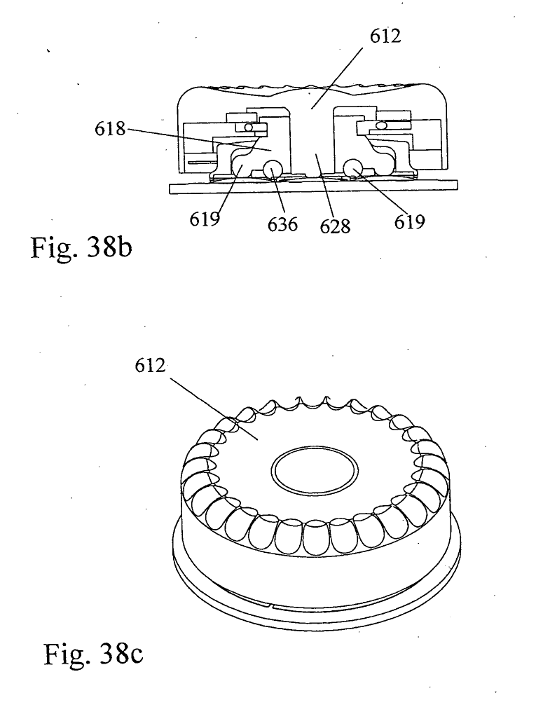

FIGS. 38a-c show another solution for a five pressure point rotary switch.

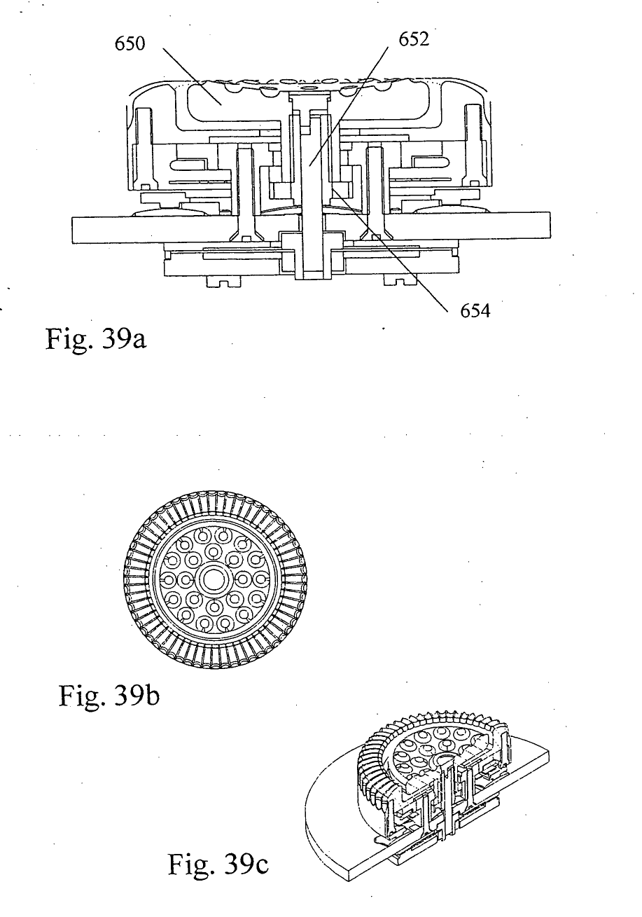

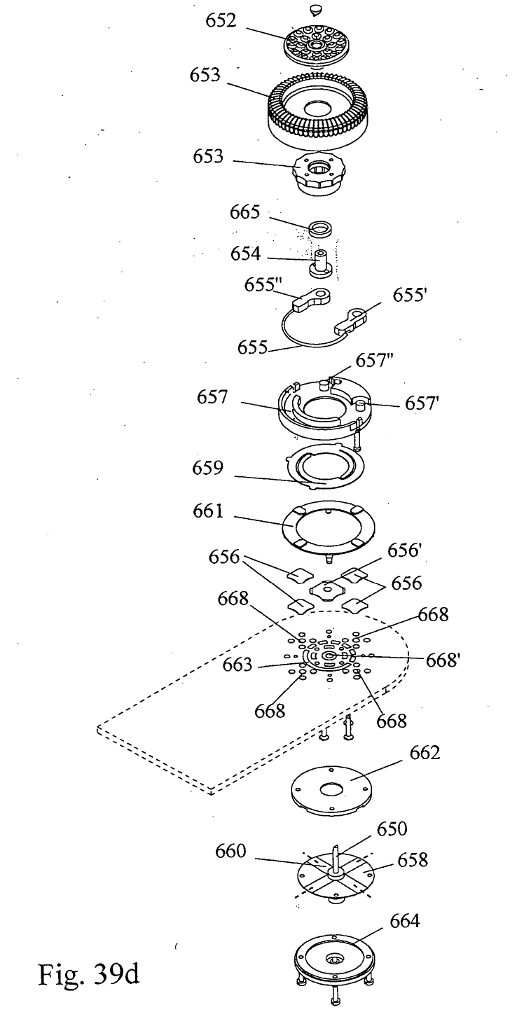

FIGS. 39a-d show a four pressure point rotary switch with a central pressure-operated switch which also has a centre position deviation function.

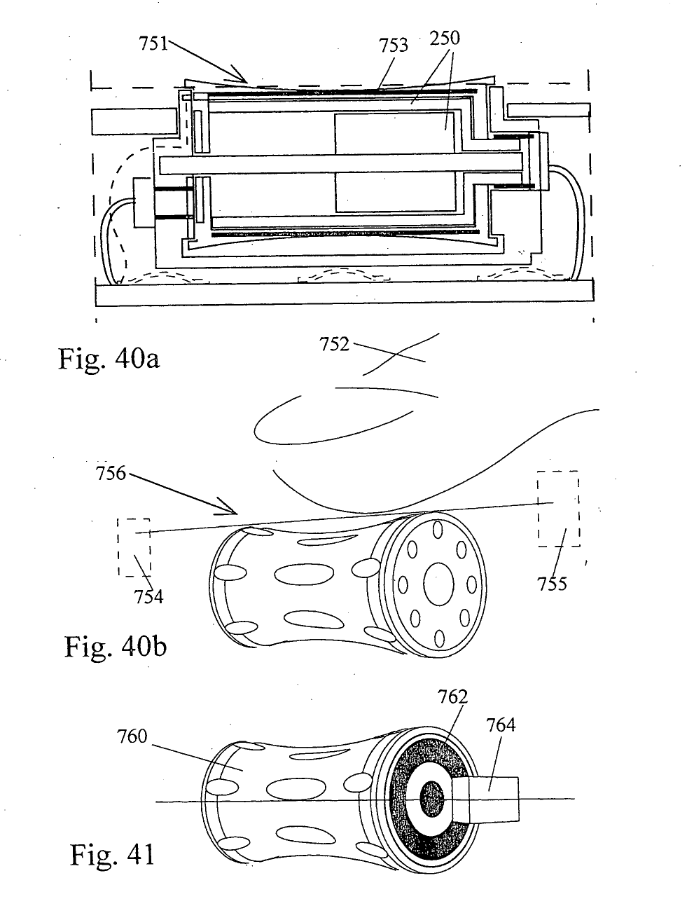

FIG. 40a-b show a roller switch with activation sensors.

FIG. 41 shows a solution for a stop function.

FIG. 42 illustrates the connection between the switch and different elements in an environment of use.

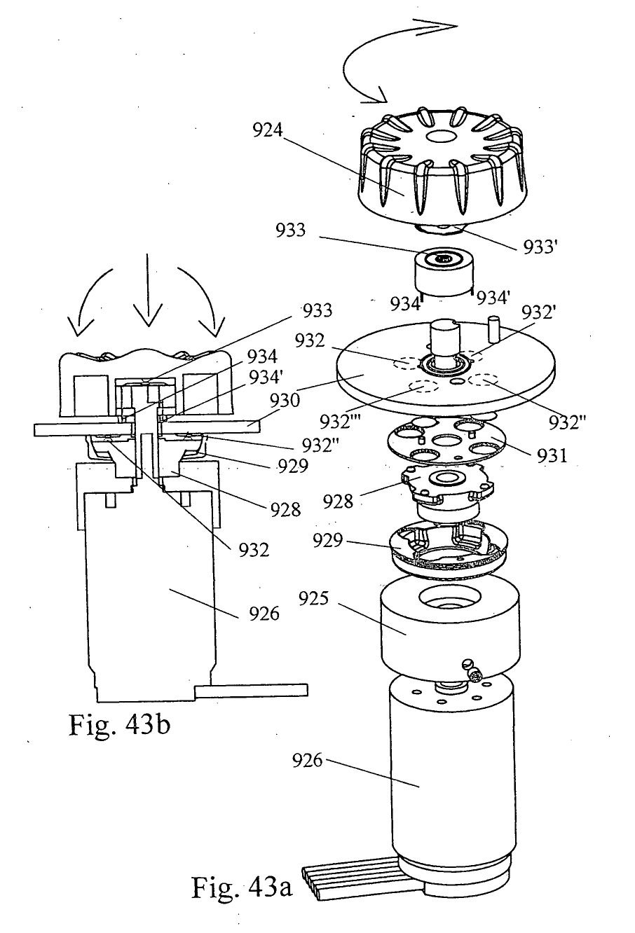

FIGS. 43a-b show a five pressure point rotary switch with a force feedback system.

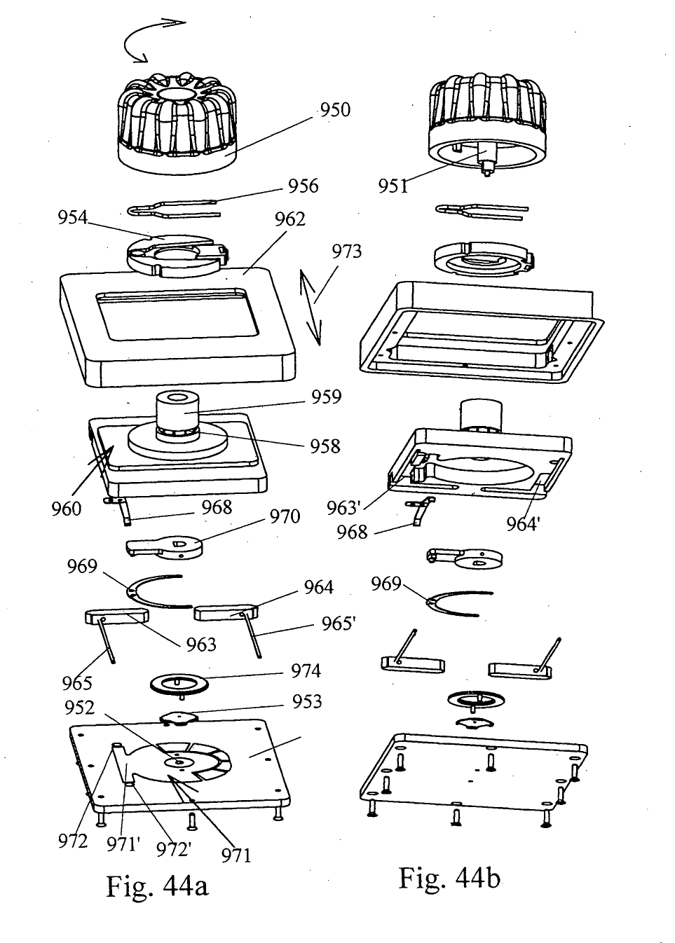

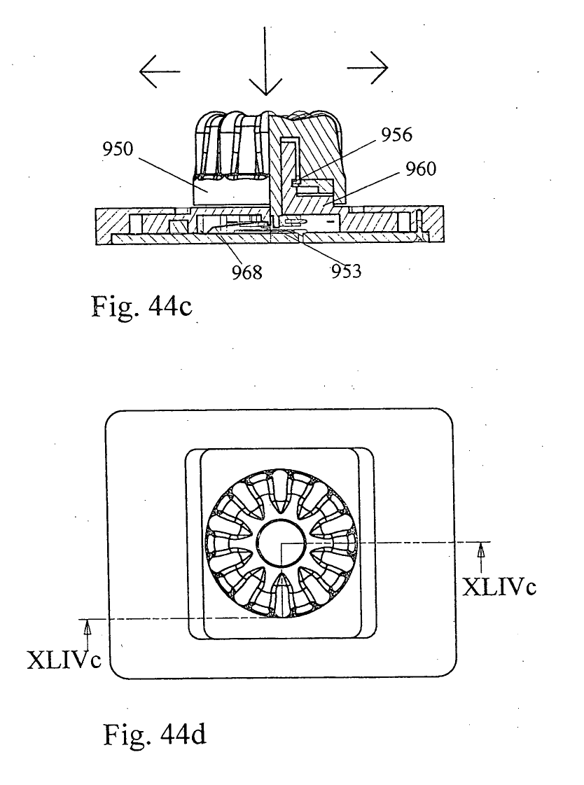

FIGS. 44a-d show a rotary switch with sliding motion.

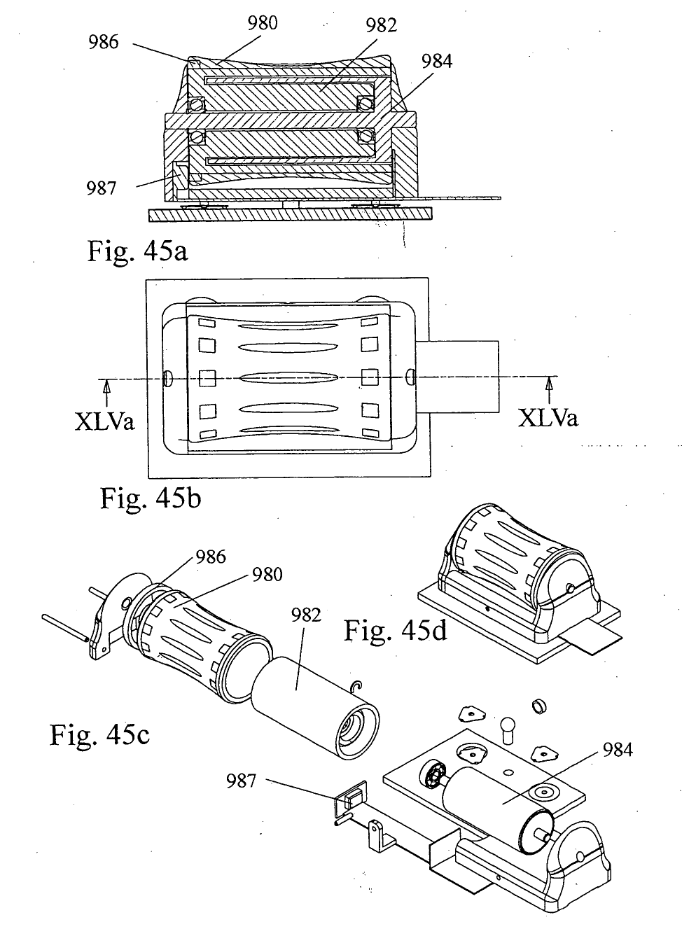

FIGS. 45a-d show variations of a roller switch with a force feedback system.

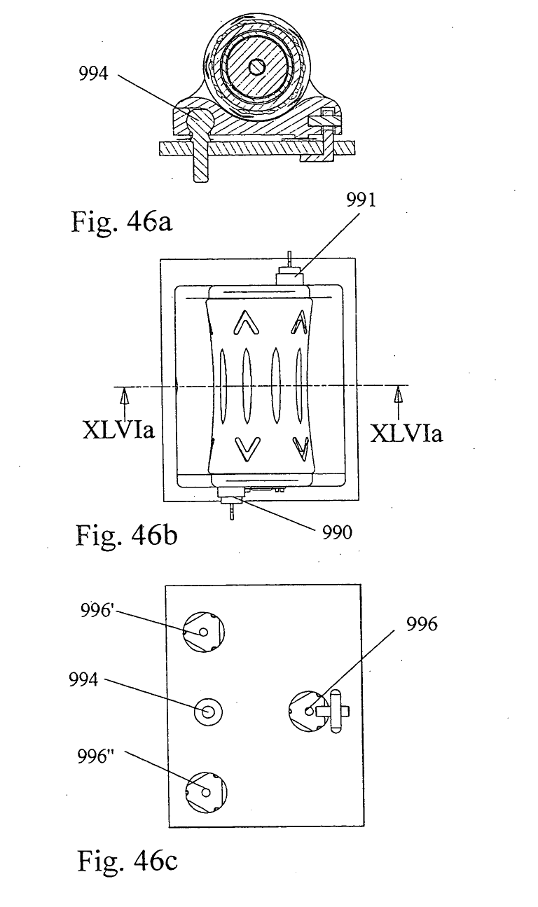

FIGS. 46a-c show another variation of a roller switch with a force feedback system.

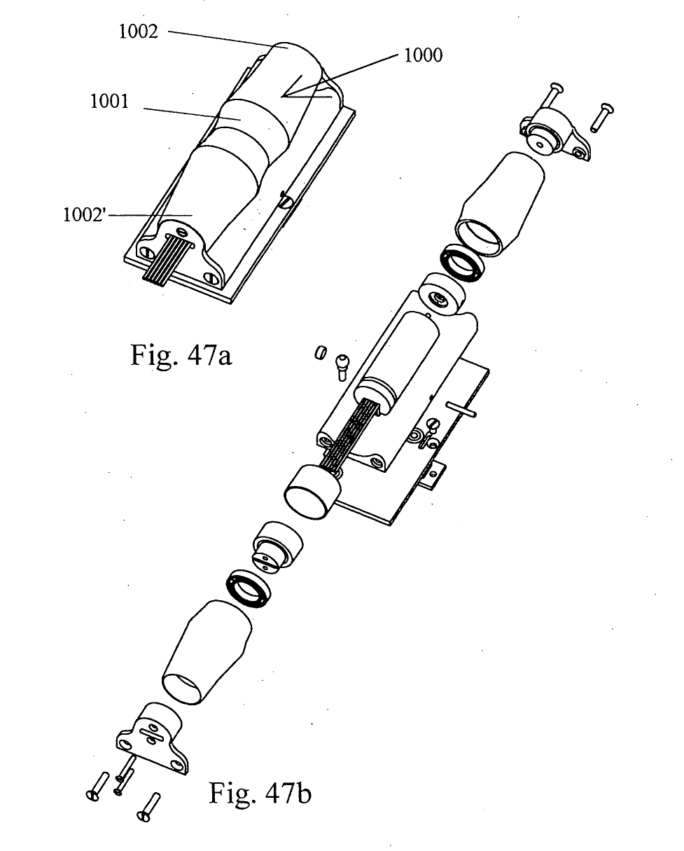

FIGS. 47a-b show yet another variation of a roller switch with force feedback system.

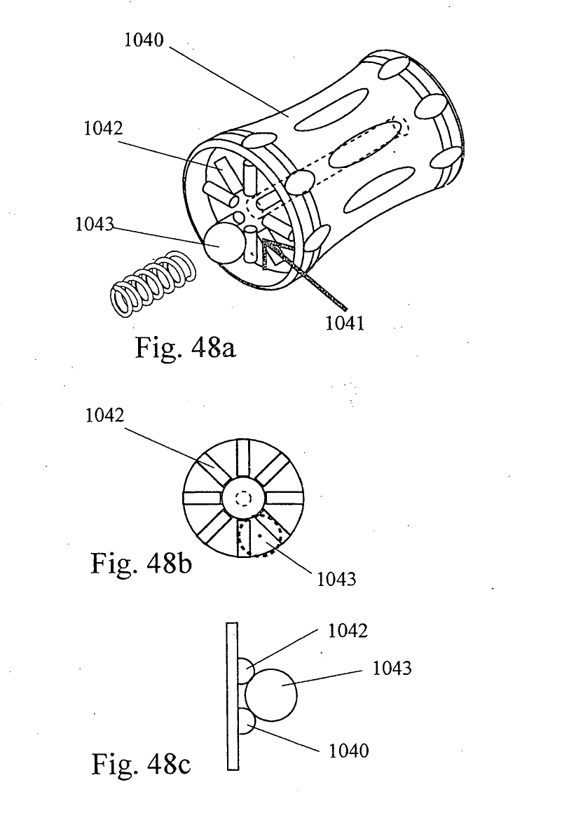

FIGS. 48a-c show a detection and step solution for roller and rotary switches.

FIGS. 1a-1d show a solution known from International Patent Application PCT/NO01/00057 consisting of a sliding switch having a depressible control element 1 which is designed on selective depression to actuate at least one of a plurality of switches 2, 3, 4, 5, and where the control element is movable, as shown in FIG. 1a, either towards the right or towards the left against the spring action of respective springs 6, 7, and where at respective end positions there are pulse generators 8, 9 to simulate a step movement. These pulse generators may, for example, function magnetically, although this should not be regarded as a limiting the scope of the invention. As can be seen from the non-limiting embodiment in FIG. 1c, repeated movements to the right will indicate respectively one, two, three four and five movement steps. However, the number of steps is not limited to only five. An alternative solution as regards movement pattern is shown in FIG. 1d.

The operating device which can be seen from FIGS. 2a-2d will be explained in more detail. FIG. 2a represents a central section of the operating device shown in FIG. 2c in the vertical direction of the drawing sheet, whilst FIG. 2b represents a central cross-section parallel to the short side of the drawing sheet. In this embodiment, there is also a control element 79 that is mounted on a slide 80 which is movable in a first or second direction along a first axis against the action of respective springs 81, 82, where the slide 80 at the end point for movement is designed to cooperate with a respective pulse generator 83; 84 in order to simulate an intermittent or step movement. The control element is provided with a plurality of pressure points (not shown) for selectively actuating switches 85-88 on tilting or depression of the control element, these switches being located on the slide 80. The control element 79 is stepwise rotatable about a shaft 89 on the slide, and the stepwise position of the control element 79 can either be detected by means of sliding contacts 91, 92 which are arranged to stepwise short-circuit contact points 93, 94, 95, 96, 97 on the slide, or can be detectable by means of contact balls. Although it is not shown in FIG. 2, the slide 80 may be movable in a third or fourth direction in a second axial direction which forms an angle of 90° with the first axial direction and against the action of spring force, where at an end point for such movement the slide 80 is designed to cooperate with a pulse generator for simulation of an intermittent or step movement.

On a closer study of FIG. 2d it will be seen that the stepwise movement is provided by means of two spring-loaded blocks 98, 99 which are mounted in a support 100, and where the support fits into an engaging part 101 which on its inside circumference has a polygonal shape as indicated by the reference numeral 101′. In this way, the elements 98, 99 will move stepwise into abutment with respective, opposite corners on the inside surface 101′.

FIG. 3 shows an operating device arrangement where the device has at least one control element 112 that is rotatable relative to the device housing 111 and designed on depression or tilting to operate various switch functions (not shown). In this embodiment, magnets or electromagnets 113 in stepwise arrangement are mounted on said housing or on a depressible carriage 115 in the housing which is supported by switches that operate the said switch functions, so that on turning cooperation with a magnetic means 114 on the control element is generated during rotation of the control element for indicating the stepwise movement of the control element 112.

The solution shown in FIGS. 4a-4c has a control element 185 for controlling user functions and where this control element has a plurality of pressure points for selectively actuating switches 186-193 located on the operating device housing 194 or on a base member 195 in the housing on tilting or depression of the control element. On its underside, the control element is cross-shaped, as indicated in FIG. 4c, and has on each arm of the cross two switch actuating buttons, as for example the buttons 196, 187, 198 and 199. The switch actuating studs on the two other arms of the cross cannot be seen in FIG. 4a. On tilting or central depression of the control element, two switches at a time are always activated by means of respective two of said pins.

In FIG. 4a it can be seen clearly that the control element 185 is a part of a stepwise rotatable control button 200. A means, e.g., of the contact field type with sliding contacts, is also provided for detecting the rotation of the operating button. The said switches which are on the operating device housing or on said base member 195 can optionally be made of a contact foil construction.

The control element is depressible and tiltable in four directions relative to two guide bars 201, 202 which extend through oval holes 201′, 202′ in the control element and are mounted in the device housing. The operating button 200 is rotatable about a pin 203 and the control element itself 198 is depressible against the action of a spring 204.

The solution shown in FIG. 4d has a control element 221 that is provided with a plurality of pressure points for selectively activating switches on tilting or depression of the control element. The switches, as for example the switches indicated by the reference numerals 222, 224 and 225, are located on an engagement block intended for an arm structure 226 in the device housing. A central depression of the control element 221 is designed to activate the centrally located switch 222 on the upper side of the block 223. The control element 221 is operatively connected to the cross-shaped arm structure 226 in order on selective tilting of the control element to actuate the non-centrally located switches, such as the switches 224 and 225. Downward tilting of the control element at a pressure point on one side relative to the centre of the control element is designed to activate a switch located on the underside of the block on the diametrically opposite side of said centre. When the control element 221 is then depressed as indicated by the arrow, the switch 225, because of the arm structure 226, will be actuated to form contact. Similarly, the switch 224 will be activated if the control element 221 is depressed on a diametrically opposite side of the control element.

As indicated in FIG. 4d, the control element can include a stepwise rotatable operating button 227, which is rotatable about a support 228. A means is provided for detecting the rotation of the operating button, e.g., through the use of contact points and sliding contacts, as indicated by the reference numerals 229 and 230.

Yet another operating device can be seen from that shown in FIGS. 5a-5d. In these figures there is a control element 248 where the control element with its operating button is stepwise rotatable about an axis and has a plurality of pressure points which indicate tilt or depression points for the control element to selectively actuate switches 249-253 that are located on a base member 254 in the device housing 255. The control element 248 consists of said operating button 248′ and also includes a cross-shaped arm structure 256 for selectively actuating the non-centrally located switches 249-252 on selective tilting of the control element operating button 248′. A central depression of the operating button 248′ will activate the switch 253 located centrally on the base member 254. The arm structure 256 is supported by a spring means 257 which is anchored to the base member 254. However, it should be noted that the arm structure 256 is not rotatable together with the operating button 248′, and thus the turning of the operating button will be detectable by a sliding contact and contact point device 258 in connection with the underside of the operating button and the upper side of the arm structure 256. Electrical connection between the base part 254 and the said sliding contacts or contact points can be provided by means of wiring 259 arranged on the spring means 257.

Another operating device according to the invention can be seen from that shown in FIGS. 6a-6c. In these figures there is a first control element 260 which is in the form of an annular body that is stepwise rotatable about a second, non-rotatable control element 261. The first control element 260 is provided with a plurality of pressure points so that on depression of a selective one thereof a respective switch in a first set of switches 262-265 arranged on a base member 266 in the device housing 267 is actuated. The second control element 261 is also provided with a plurality of pressure points, in order on depression or tilting at a selective one thereof to actuate a switch in a second set of switches 268-272 arranged on said base member 266. On its underside, the second control element 261 comprises a plurality of switch actuating pins, of which three, indicated by the reference numerals 271′, 272′ and 269′ are shown in FIG. 6b.

These switch actuating pins 268′-271′ will, on selective tilting of the control element 261, actuate the respective non-centrally located ones of the switches 268-271, whilst central depression of the control element 261 will cause activation of the switch 272. The second control element 261 is supported by a spring means 273 which is anchored to the base member 266. Rotation of the first control element 260 can be detected by means of a sliding contact and contact point device 274 in cooperation between the underside of the first control element 260 and an opposite portion 267′ on the device housing.

In the embodiment illustrated in FIGS. 7a-7b, there is a control element 275 that is stepwise rotatable about an axis and where the control element operating button 275′ is provided with a plurality of pressure points for selectively actuating switches 276-289 arranged on a base member 281 in the device housing 282 on tilting and depression of the control element. The control element 275 is operatively connected to a cruciform arm structure 283 which has switch actuating pins 284, 285, 286, 287, or optionally an annular structure having a plurality of switch actuating pins, so that on selective tilting of the control element one of said switches 276-279 which are not centrally located can be actuated.

A central depression of the control element operating button 275′ will activate the centrally located switch 280, a switch actuating pin 288 being connected to the operating button 275′ and sliding through a central hole 283′ in the arm structure 283. The turning of the operating button 275′ is detectable by means of a sliding contact and contact point device 289 in connection with the underside of the operating button 275′ and an opposite portion on the device housing 282 or optionally on the base part. The operating button 275′ will, with the aid of a spring means 290, form spring engagement with an upper neck portion 283′ on the arm structure or on a shoulder part of said annular structure. In the illustrated embodiment, the neck portion 283′ has a corrugated circumference in order with the aid of the spring means 290 to cause stepwise rotation of the operating button.

FIGS. 7e-7i show how a sliding contact device 291 could form functional cooperation with contact point device 292 on a base member 293. As shown in the exploded view in FIG. 7e, the operating button 275′ could be given a stepwise movement by means of a toothed wheel 294 and spring arms 295 when this unit is mounted on a support 296. A back-up ring 297 is supported on the base part 293 and when tilted will actuate the switches 298, 299, 300 and 301. As will be seen from FIGS. 7f, g and i, this variant of the switch structure shown and described in connection with FIGS. 7a-7d could be compacted, i.e., given a smaller axial extent than would otherwise have been possible.

It is important to be able to optimise the dimensions of the control element relative to the steps through which this can be moved, and when the control element is a stepwise rotatable disc or operating button, where the disc has a diameter d in millimetres, and where the number of steps the disc can be turned is n, there is provided according to the invention a constant k ε [d/n)], wherein k=1.7-2.4 mm/number of steps. This is shown in more detail in FIG. 7c, but it will be understood that this will apply to all control elements made in the form of an operating button.

Other aspects of the present invention will now be described with reference to FIGS. 8a-8j and FIGS. 17a-17f.

FIG. 8a shows an operating device with a roller-shaped control element 302 which is stepwise rotatable about a shaft and provided with a plurality of pressure points for selectively actuating switches arranged on a base member 303 on tilting or central depression of the control element. In the illustrated example, the stepwise rotation can be provided by a toothed wheel 304 which a spring 305 is arranged to turn.

The control element 302 is rotatably supported about a shaft 306 in a cradle 307 which is supported by three spring-equipped switches 308, 309 and 310. One of the switches, such as the switch 309, will normally be on one side of the shaft 306, as can be seen from FIG. 8d, and the two other switches 308 and 310 are on the opposite side of the shaft 306. A central depression of the control element 302 will activate the centrally located switch 309. On depression at one end or the other of the control element, the cradle will tilt and actuate either the switch 308 or the switch 310. In the illustrated embodiment, rotation of the control element 302 will be detectable by a sliding contact and contact point device 311 in association with an end member of the cradle and an end portion of the control element. In this connection, reference is made in particular to FIG. 8b. As indicated in FIG. 8e, the stepwise movement of the control element 302 is provided by means of two spring-loaded pins 312, 312′ which bear against a polygonal inner flange 302′ on the control element 302. Further details of the sliding contacts and the contact point device can be seen from FIGS. 8i and 8j respectively, indicated by the reference numerals 311′ and 311″ respectively. On studying FIG. 8, it will be understood that the switches 308-310 are selectively activatable by depressing or tilting the control element, the underside of the cradle 307 actuating the switch in question. The shaft 306 in the illustrated embodiment in FIGS. 8b-17j is mounted in elongate holes 313′, 314′ in posts 313, 314 which extend up from the base part 303 or in the device housing. Such posts are not shown in FIG. 8a, as the cradle in the example illustrated in that figure is connected to the base part 303, for instance via a flexible connection 315. As indicated in FIG. 8h, the control element can be made movable along the shaft 306 in order to activate an additional switch function. This additional switch function can, e.g., be provided by the sliding contacts 311′ loosing contact with the contact point device 311″.

FIG. 17 shows a variant of the solution shown in FIG. 8. Here too, there is a control element 302, a base part 303, switches 308, 309 and 310. The shaft 306 which runs through a longitudinal hole 302′ in the control element 302 is supported in elongate holes in end members 316, 317. The control element 302 is rotatably supported relative to a cradle 318 and the stepwise movement is provided in that the control element 302 has a toothed or corrugated flange portion 302″ which can engage with a spring-loaded ball 319. The elongate holes in the end members 316, 317 are indicated by the reference numerals 316′, 317′.

The solution shown in FIG. 17 also has a variant of the mode of detection that is related to finding the rotational position of the control element 302, and this is provided by a solution where a conducting field or magnetic field 320 is arranged in a stepwise isolated pattern 320′ close to the shaft 306. A reading sector 321 is provided on the cradle 318, but this reading sector will usually not cover more than about half of the circumference of the conducting field or magnetic field 320. Thus, the cradle 318 does not cover the upper part of the portion 320. However, this portion is covered by a cover 322 which is placed on top of the end members 316, 317. Pins 323, 324 projecting down from the cradle 318 will on direct depression on the centre of the control element 302 engage with holes 323′, 324′ in the base part 303. However, on tilting or depression of an end portion of the control element 302, the pins 323, 324 will be turned so much that they will not engage with the holes 323′, 324′. This ensures that there is no form of erroneous detection. In FIG. 17e a braking device 325 is provided. On depression of the control element 302, friction between the control element and the device 325 is obtained, thereby preventing or at least braking rotation.

In connection with that shown and described in connection with FIG. 8 and FIG. 17, reference will now be made to FIG. 9.

In FIG. 9a and FIG. 9b it will be seen that on an end portion of the control element, also indicated by the reference numeral 302 in these figures, there is a ring of n holes 326 which stepwise on rotation of the control element 302 engage with a spring-loaded pin 327. In this connection, reference is also made to FIG. 8g. In FIGS. 9a, 9c and 9d, in addition to the control element 302, there is also a second and a third control element indicated by the reference numerals 328 and 329. These control elements are connected via hinges 328′, 329′ to a respective long side of the cradle 307. A spring-loaded switch 330, respectively 331, is positioned between the base member 303 and the underside of said second and third control element for effecting on depression thereof a supplementary switch function.

It is important to be able to optimise the dimensions of the control element in relation to the steps through which it can be moved, and when the control element is a stepwise rotatable roller or drum which has a largest diameter d in millimetres, and where the number of steps the drum can be turned is n, there is according to the invention a constant k ε [d/n)], wherein k=1.5-2.0 mm/number of steps. This is shown in more detail in FIG. 9c, but it will be understood that this will apply to all control elements made in the form of a roller or drum.

FIGS. 10-12 indicate an operating device, especially for controlling user functions in electronic user equipment in interaction with a display screen (not shown). The device as shown in FIG. 10 has a control element 383 which can be provided with a plurality of pressure points for actuating a switch in a set of switches on depression or tilting at a selective one of the pressure points. However, for clarity, these switches are not shown in this simplified figure, but will be immediately conceivable from what has been shown and described earlier in the present description and with reference to the drawings. It will be desirable, especially on central depression, but also on the tilting of a control element of this kind, whether it has a horizontal shaft as shown in FIGS. 10 and 11 or a vertical shaft as shown in FIG. 12, to be able to lock the control element against rotation during activation of a switch. As shown in FIGS. 10a and 10b, depression will result in a wedging action between the control element 383 and a wedge-shaped means 384. In the solution shown in FIG. 12 , the control element is indicated by the reference numeral 385 and the wedging means is indicated by the reference numeral 386. Both on central depression of the control element 385 and on depression close to its periphery, it will be possible to obtain a wedging action, and thus a locking of the control element 385 relative to the operating device housing 387, so as to cause a definite activation of a relevant switch. Thus, in connection with the embodiments in FIGS. 10 and 12, a clamping wedging action is employed. In the solution shown in FIG. 11, however, a plurality of cut-outs 388 are provided on the control element for causing engagement between the cut-outs 388 and a locking pin 390 on the housing 391 when the control element 389 is depressed.

FIG. 13 and FIG. 14 show two alternative solutions based respectively on the solution shown in FIG. 11 and that shown in FIGS. 10 and 12. In FIG. 13 it will be seen that pins 393, 394 are provided in connection with the operating button 392 which are designed to form a releasable engagement with cut-outs 393′, 394′ in the operating device housing 395. However, it will be understood that instead of engaging with said housing, the control element, here symbolised by the operating button 392, will also be able to engage with a cradle or a support if the control element has a design other than that shown here. Furthermore, FIG. 14 shows that the operating button 396 has a rounded or bevelled portion 396′ which on depression of the control button is designed to form clamping engagement with a bevelled portion 397 of the device housing 398. However, said housing 398 can also be regarded as being related to, for example, a cradle or a support that is an integral part of an operating device if, for example, the control element has another design, e.g., a roller form.

In FIG. 15 shows a horizontally arranged rotary switch which on depression is locked against further rotation. It will be seen that a large number of pins 400 are arranged on the housing 399 for locking the control element operating button 410 against rotation by one of said pins 400 engaging with a cut-out or hole 402 on the underside of the operating button 401. The construction shown in FIG. 15 is also related to that shown and described in connection with FIGS. 7a-7d and a further explanation is therefore not required.

FIG. 16 shows an operating device for a control element 403. The control element is arranged on a cradle 404, and the control element 403 is provided with a plurality of pressure points for selectively actuating switches located on the operating device housing or on a base member thereof on tilting and depression of the control element. The control element is a roller that is rotatably mounted on a shaft 405 in the cradle 404, and rotation of the roller is detectable by means of a sliding contact and contact point device 406 in connection with an end member of the cradle and an end portion of the control element. The switches, as indicated by the reference numerals 407, 408, 409 and 410, are preferably made of a contact foil construction, although this should by no means be regarded as limiting for the invention. The cradle is centrally depressible, but also tiltable relative to two guide bars 411, 412 which extend through oval holes 411′, 412′ in the cradle and are mounted in the device housing or in member 413 which projects up from a base part 414 of the operating device.

The said switches 407-410 are selectively activatable by depressing or tilting the control element 403, whereby the underside of the cradle actuates relevant switches. However, it is important to note that either on central depression or on sideways tilting of the control element and thus the cradle, two switches are always activated at a time. Thus, either the switches 407, 408 will be activated together, the switches 408 and 409 will be activated together on central depression, or the switches 409 and 410 will be activated on sideways tilting.

FIG. 18 and FIG. 19 have been included to illustrate aspects of the present invention associated with the concept of “force feedback”. The solution shown in FIG. 18 in particular can be envisaged in connection with the solution shown in FIG. 3. The idea here is to be able to supply electricity to generate magnetism and bring about voltage between the static part 415 and the rotatable part 416. In this way it will be possible to program a roller detection, and make it possible to stop or brake the rotation electrically by controlled magnetism, e.g., when moving through a menu, but then moving towards the end or the start of such a menu. The magnetic elements used are merely indicated by FIG. 18 by the reference numeral 417. The power-supplied elements for generating magnetism are indicated by the reference numeral 418 in FIG. 18. Similar technology could also be used for a control element 419 which has a vertical shaft as shown in FIG. 19.

FIGS. 20-26 show the principle of a variant of the operating devices described thus far, especially in connection with a device where the control element is rotatable.

In the solution shown in FIGS. 20 and 21, it is assumed that the control element, indicated by the reference numeral 420, cooperates with or is an integral part of a so-called step motor. A step motor of this kind may be connected to equipment for performing operations selected from the group: controlling the number of steps, controlling the space between steps, controlling the force the user needs to apply, braking or stopping movement of the control element 420, causing a back or return movement, or stimulating or oscillating (small reciprocating motions) and detecting movement and direction of movement. As shown in FIGS. 20 and 21, it is intended that the step motor casing should form the control element 420, whilst the step motor rotor 421 and rotor shaft 421′ are maintained stationary. However, it is conceivable that the step motor rotor shaft 421′ can be connected to a control element and that the step motor casing is arranged to be stationary. This is shown in more detail in FIG. 26 where the control element with an operating button is indicated by the reference numeral 422, the step motor shaft is indicated by the reference numeral 423, the step motor rotor is indicated by the reference numeral 424, and the stator of the motor is indicated by 425. A rotation detector 426, 426′ can be mounted in connection with the step motor to detect the mutual rotation between the motor casing and its shaft, as for instance indicated in FIG. 20.

Use of a step motor in connection with a roller switch is a new concept. The idea here is to be able to control, i.e., actuate during use, rotation of the switch by coding a microprocessor, which communicates with the programs in a functional apparatus. One object is, for instance by means a combination of magnets and/or electromagnets, to provide fields of force that simulate steps, instead of springs and grooves. By using a step motor it is possible to make movements of the rotation of the control element (the roller) which become interactive with presentations on a display.

This means that if the user has a menu through which he scrolls, the roller can be caused to brake or stop at the end of the menu list. In FIG. 21, the shaft and the rotor 421 must be fixedly mounted, and the roller will be attached almost like a coating on the outside of the motor stator 420, which will now be able to rotate.

FIGS. 22a, 22b, 23a and 23b show a principle where there are fields which can be charged (optionally are fixed, magnetic) along the shaft of the roller and inside the roller. In FIG. 22, the reference numeral 427 denotes a rotor shaft, 428 a roller (the stator frame of the motor), 429 an active winding and 430 a winding. In FIG. 23, the reference numeral 431 indicates a magnetically charged shaft, 423 a roller (the stator frame of the motor) and 433 a winding. In effect, it is shown how a step motor can be used in this connection, and the mode of operation is in other respects known to the skilled person. FIG. 22 shows windings arranged on the inside of the roller, i.e., on the movable part of the switch. On rotation, power is supplied to all or a selected number of the windings to create steps. By further supplying power, it is possible to brake or stop, or optionally reverse the roller, for example, in connection with said menu scrolling. In step motor technology it is also possible to program in different step variants. In one situation, it may be desirable to have many steps per rotation, e.g., 18, whilst in another function 9 is more appropriate.

The use of a step motor/flux will make it possible to employ fixed magnets in cooperation with electrically loaded windings, or to only employ windings so that it is possible to control all the steps. FIG. 22 shows a solution where only windings are used. In this case, fixed mechanical steps will have to be used if power is not supplied to the windings at all times.

FIG. 23 shows an example of windings which cooperate with fixed magnets. In this case, it is possible to avoid mechanical steps, but the possibility of removing or changing the steps will then be limited.

FIG. 24 and FIG. 25 show variants of FIG. 22 and FIG. 23. In FIG. 24, the reference numeral 434 denotes the fixedly mounted rotor of the motor, 435 is a roller which forms the control element and which consists of the motor stator and is in this case designed to rotate because the stator is held still, and in FIG. 25 the reference 437 indicates a rotor that is held still, 438 is the stator frame which in this case is to rotate, and 439 indicates a metal piece that is not charged, but is actuated by energised windings which pass by. When there is a switch that is to be rotated, it will be appropriate that the parts which rotate are non-current carrying, i.e., that in this case they do not have windings. Arranged inside the roller (stator frame) or a rotatable disc member are magnets or metal that is attracted to/repelled from the windings.

As regards detection of rotation and direction, this can conceivably also be done by measuring the force and the direction of the magnetic fields which will change when this technology is used. There are also possibilities for combinations of the principles described, but these will not be discussed in more detail here.

When using the suggested flux principles, it will normally not be necessary to install extra technical equipment to detect movements, its steps and direction. The direction of the current will at all times be known, and the fields of force are measurable, which means that the direction of movement of the operating device can thus be deduced. Alternation of the fields of force will indicate the number of steps over which such a device moves.

Use of step motor technology, especially with sufficient miniaturisation, will be applicable in a number of operating devices of the rotation. Examples in this connection are, for instance, variants of the solutions that can be seen in FIGS. 3, and FIG. 18. Thus, it is conceivable that the solution could be applied to roller switches and rotary switches.

A rotatable multifunction roller switch with built-in electromotor or step motor and three presses, or pressing and two-way tilting function is shown in FIGS. 27a and 27b. The operating device of the switch 501 is mounted in a carriage or frame 503 which rests directly on three springs 505-505″. The reference numeral 507 indicates an elevation which prevents the collapse of more than one spring at a time. The operating device 501 of the switch forms an outer part of the motor together with the coil 502. The inner magnetic part 504 is then fixed. The coil is supplied with power via brushes 508 in a known way. At the other end of the rotating switch part, the rotation and its direction can be detected as indicated by the reference numeral 509. This can be done by using a selection of the techniques that will be described in connection with FIG. 29. Depression or tilting of the operating device 501 is detected in that springs 505 mounted on an underlying circuit board with contact points, collapse when downward force is applied to the switch element. The point of an electromotor inside a switch of this kind is to be able, during use, to give a counterforce which the user will feel on his finger, illustrated in FIG. 27c. A motor of this kind is a common commercial product, but according to the invention it is used in an entirely different manner than the intended normal use of the motor.

FIG. 28 shows a roller switch with a motor mounted inside the operating element. The operating element is mounted in a frame or carriage 503 and is rotatable relative thereto.

The frame may be fixed as shown in FIG. 28a, or mounted as shown in FIG. 28b where the switch is tiltable and depressible about a shaft 510. As shown in FIG. 28d, the frame consists of a base part 519 and two side members 519 and 519′, and an intermediate connecting piece 517. The frame as shown in FIG. 28b has an element 511 secured therein which is movable up and down, but not turnable to prevent rotation about the shaft 510. The coil part 502 is in fixed connection with the operating element 501. However, between the coil and the operating element is a metal sleeve 520 of iron to provide magnetic return of the magnetic field. This sleeve will thus “compress” the field of force. The coil is supplied with power via brushes 508 which are connected to connector terminals 512, see FIG. 28c. The coil 502 is supported at one end by a bearing 515 and at the other end by a bearing 514 which lies between the coil and the magnetic part 504. The rotation in this figure is read by using Hall sensors which sense change in polarity. A ring 516, see FIG. 28a and FIG. 28d, consists of magnets having varying polarity. Two Hall sensors 518 lie and sense the rotation and its direction. Connection points are passed out at terminals 513, see FIG. 28c. The stepwise sensing during use is generated by supplying alternating current to the coil 502 which is controlled by the readings from the Hall sensors 518.

FIGS. 28f-28t show possible pressing functions that the switch can have, i.e., none, two or three. In use, this can be combined with external pressure-operated switches in interaction with systems that are commented on further in connection with FIG. 42.

FIG. 29 shows other alternatives for detection of rotation than those explained in connection with FIG. 28. Rotation can be detected by using resistors 521, 522 having different values as illustrated in FIG. 29a, and where resistor overlapping is provided, and by using sliding contacts 521′, 522′. Detection by using sliding contacts 523 against contact points 523′ is shown in FIG. 29b. CD-ROM 524 or a floppy disc 525 technology can also be used together with optical and magnetic detectors 524′, 525′, respectively, as illustrated by FIG. 29a and FIG. 29d respectively. Pure optical reading by using a light emitter and light receiver 526 in connection with reflection from a disc 526′ as shown in FIG. 29e or by using light emitter 527 and light receiver 527′ for detection of light through holes 527″ in a rotatable disc 527′″ as shown in FIG. 29f. The technique shown in FIG. 29 is known to anyone of ordinary skill in the art and will therefore not be described in more detail.

Furthermore, it will be shown how rotary switches can be actuated by an electromotor, or step motor where this is not mounted inside the control element. FIG. 30 shows how an operating element or control element 530 can be connected to a gearwheel 531 via an internal gear rim 532. FIGS. 30a-30d show how the gearwheel 531 meshes with the teeth 532 on the inside of the operating element 530. If a depression function is present, as in the case of FIG. 30d, shown by FIGS. 30b-30c, the gearwheel 531 will be able to disengage from the gear rim 531. The advantage here is that the motor 533 and the connection 534 to the gearwheel 531 may be fixed.

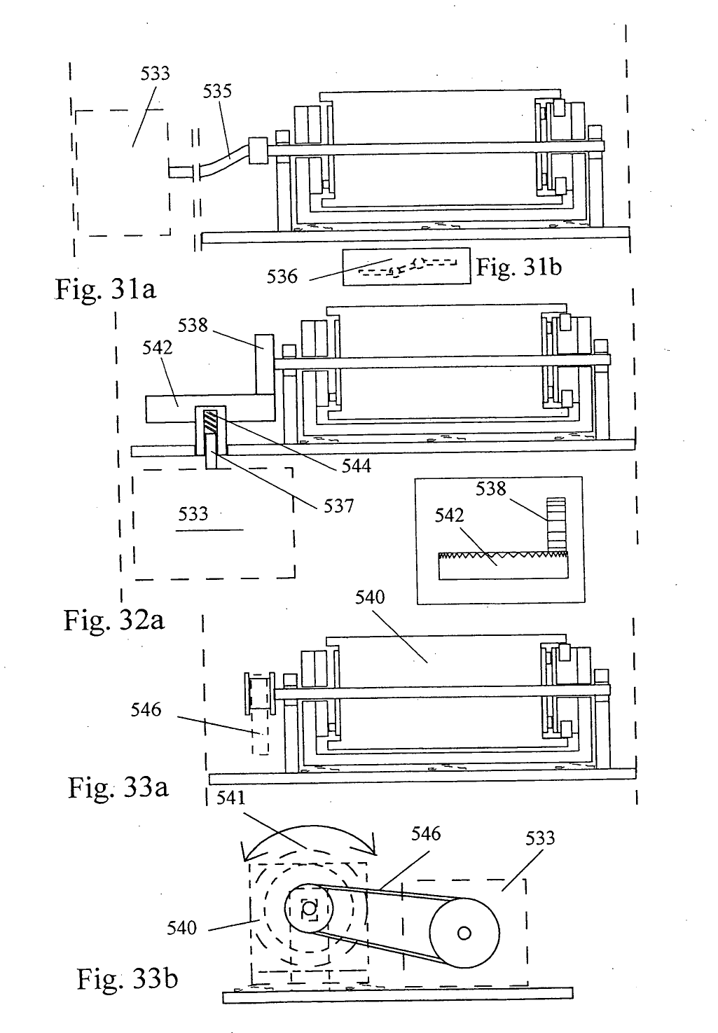

FIGS. 31a and 31b show how force can be supplied through a mechanical connection 535, e.g., a Bowden cable connection, a wire connection, or a connecting member of flexible material or structure. The connection may also be via an articulated shaft, e.g., double universal joint connection 536.

FIGS. 32a show how it is possible to transmit force via a gearwheel 538 mounted in the extension of the shaft of the operating element 540. Mounted on the motor shaft is a gearwheel 542 which meshes with the gearwheel 538. On depression or tilting of the switch, the gearwheel 542 will spring towards the motor shaft 537 shown with the aid of a spring 544.

FIGS. 33a-33b show an embodiment for force transmission via a belt 546. The belt may be smooth or toothed. The belt will be so flexible that there will be no problems in connection with the depression of the operating element 540, as indicated by the arrow 541.

FIGS. 34a-34c shows a five pressure point or pressure and four-way rotary switch as previously shown in connection with some of preceding Figures. Here, the switch is shown with force transmission via gear wheel 549 and gear rim 550″ on the operating element or control element 550, see FIGS. 34a and 34b, and alternatively with a belt transmission as shown in FIG. 34c. In both cases, the motor 547 shaft 548 is parallel to the axis of rotation 550′ of the switch. This permits transmission of force directly on the switch operating element 550 which then will have a partly toothed periphery 550″, i.e., said gear rim.

FIGS. 35a-35e shows a four pressure point or tiltable rotary switch where the operating element 552 is mounted directly on the shaft of the electromotor 554. The connection point 556 on the electromotor is spherical, has engaging teeth and is part of a tiltable, but non-turnable fixing point 558 on the underside of the operating element 552. The figure also shows a ring 560 which when mounted in an apparatus will be joined together with the apparatus housing. The reference numeral 562 represents a disc that is fixedly mounted, but is movable downwards for pressing springs 564 and contacting with contact points 566 on a circuit board 568. Electrical connections to the motor 554 are indicated by the reference numeral 569.

FIG. 36 shows a rotary switch with central depression and four-way tilting, or pressure positions axially mounted on a motor 573 for force feedback. The motor shaft 570 here passes through a central spring 572 and contact point or switch in the circuit board and the central depression part or the stem 576. The switch itself is otherwise essentially like the solution described in connection with FIG. 37.

In connection with FIGS. 37a-37d, a rotary switch with central depression and four-way tilting or pressure positions will be described. Switch part 580′, together with the rotation, tilting and pressing part 582, forms the operating element 580. The operating element or control element is mounted so as to be stepwise rotatable about a frame part 584. A spring 586 is secured to the part 582 and springs against a polygonal peripheral portion or steps 588 on the frame part 584. About the downward projecting portion of the part 582 is a tilting part 592 with four arms, like a spider. This is not actuated by direct depression, but will tilt and collapse switch springs 594 on sideways pressure on the operating element. A shaft part 596 is fixedly connected to the part 582 and is in engagement with sliding spring 598 or a modification 599 thereof. On rotation of the operating element, the spring will run across the circuit board 600 where this has a detection ring 602. The reference numeral 604 is a depression part for central depression of the operating element for collapsing a spring 606. Four lateral tilt contact points 608 are placed in a separate, but parallel plane in this construction, although they could conceivably be placed in the same plane. FIG. 37c shows a small variant where the central shaft part 596 is mounted so as to be axially movable about the operating element 580. Mounted between the downward projecting part 590 and the shaft part or stem 596 is a spring part 610, for example, an O-ring of an elastically yielding material. This means that on depression the spring and contact points on the circuit board will not be unduly loaded. The actual design of the touch part of the operating element may of course vary, but to obtain an exact feeling of central depression a small peak 580″ is formed in the centre. For finger friction during rotation, there is also a ridged pattern 580′″ in the periphery.

FIG. 38 a shows a rotary switch with central depression and four-way tilting or pressure positions of a slightly different construction than that shown in FIG. 37. An operating element 612 consists of a touch part 612′ fastened to a rotary part 614. Fastened to the rotary part 614 is a spring 616 which on rotation of the part 614 gives a stepwise movement about a polygonal portion or steps 620 on a spider or tilting part 618. The part 618 has four feet or small arms 618 which rest on four spring 622 and are held rotatably fixed, but tiltable by a frame part 626. A shaft part immediately below the touch part 612′ passes through the rotary part 614, and is axially slidable and rotatable about the parts 626 and 618 and rests on a spring 624. On central depression of the operating element, the spring 624 will collapse. Secured immediately below the part 614 is a spring 630 for detection of the stepwise rotation. This spring, which normally spans across an angle slightly greater than 180°, is in contact with the circuit board 632 and its contact field 634. An O ring 636 is placed between the part 618 and an insulating layer 638. The design of the finger touch part of the operating element is in principle the same as that described for FIG. 37.

Another variant of a rotary switch with central depression and four-way tilting or pressure positions will now be described in connection with FIGS. 39a-39d, but this switch has in addition a central position deviation function. A pin 650 through the centre of the structure is in engagement with a central control element 652 which can be moved axially relative to the pin 650 in order on depression to push down a shaft part 654 and cause collapse and contacting of a central switch contact point part 668′ on the circuit board which cooperates with a central contact spring 656′. On sideways displacement of the element 652, a disc 658 will be made to turn and this will be detected by strain gauges 660 mounted thereon. This forms a starting point for calculating a deviation in the centre position which can be transmitted to cause a screen pointer to move freely on a display screen. The parts 662 and 664 form a supporting frame for the disc 658 and are fastened beneath the circuit board 666 which contains contact points 668, 668′ for the total of five depression points and possible rotation that this switch solution has. The contact points 668 cooperate with respective contact springs 656. It will be noted that the pin 650 extends through a hole in the central one 668′ of the switches' contact point parts and similarly through a hole in the contact spring 656. The parts 651, 653, 655, 657, 657′, 659 and 661 will now be described. The reference numeral 651 represents a control element which encircles the control element 652. The rotatable control element 651 rotates relative to a fixed element 653 through which the pin 654 extends. The element 653 has a toothed periphery and forms, with the aid of spring 655′, spring engagement with pins 655, 655′ that are mounted on a supporting disc 657 and mounted there with their respective holes on journals 657′, 657″. A combined rotation detector and spring 659 is provided and cooperates with contact field 663 on the circuit board 666. A non-rotatable depression element 661 is arranged for actuation of the springs 656 on tilting/depression of the element 651. The reference numeral 665 denotes a sleeve.

A solution to a problem relating force feedback (FF) will be described below with support from FIGS. 40a and 40b. By using a solution having a motor 750 inside a roller switch 751 without introducing fixed steps on the switch as shown in, for example, FIG. 28, the motor has to be supplied with current to have fixed or noticeable steps. The current can be activated as the user starts to rotate the switch. The switch will nevertheless give the user the feeling that it is loose and almost free-rolling as the user starts by moving it so that it begins to rotate. To avoid this, different methods may be employed to detect that a finger is about to come into contact with the switch. FIG. 40 a outlines that a conductive or capacitive technique can be used to effect this detect. When a finger 752 touches the switch control element 753, the conductive or capacitive sensor 753 will send signals via a processor (not shown) which activate the switch before the user has started to rotate it. Steps and detection that are provided by means of the motor 750 will then be activated at once. This solution is of particular importance in connection with a power saving function, as continuous power supply to the motor, even when the multifunction switch is not operated by the user, will increase the power consumption per time unit considerably and be particularly problematic in connection with battery operation of electronic equipment. FIG. 40b shows an alternative solution where optics is used. Light transmitters 754 and receivers 755 can form beams which are broken when the switch 756 is touched. Alternatively, it is conceivable that the receiver 755 is an infrared detector that detects the presence of the heat of the finger or that an infrared detector registers that the user is approaching the multifunction switch on the electrical equipment. In this case, a light transmitter is not required.

Another problem with a switch that has no fixed mechanical steps will be that when it is not in use it will be slightly “loose”, i.e., it can easily rotate in an uncontrolled manner. FIG. 41 shows a principle where the rotary element or the roller 760 has a field 762 against which a piezoelectric element acts and can lock the rotating movement. When voltage polarity of the element is right, the locking or braking effect can be neutralised. Two areas of use are conceivable, one being to lock the switch when it is not in use. The other will to be lock the switch in connection with navigation in a menu which will be described in more detail in connection with FIG. 42.

All the solutions presented in this description could be used for the system that will be described in connection with FIG. 42. In addition, reference is made to the Applicant's international patent applications, PCT/NO00/00412 and PCT/NO01/00056 and Norwegian Patent Application NO 2001 4796.

The reference numerals 770-770″ refer to alternative multifunction switches, where 770 denotes a roller switch, 770′ denotes a tilting switch or a sliding switch, and 770″ denotes a disc-shaped rotary switch. These may be exposed to a source of force for force feedback (FF) indicated by the reference numeral 772. Movement of the switch is detected by the element or elements indicated by 774. These signals are processed by processor 776 that is connected to a computer 778 for further processing in interaction with a computer program 780, or directly to the control unit 772 that actuates the switch. Signals pass via the computer (PC) to a screen 782 which interactively shows menu alternatives, functions and results in response to the use of the switch and information to the user about the state of the apparatus 784. Apparatus in this context can be anything from a mobile telephone to a vehicle. Functions are represented by the reference numeral 786 and will be controlled by different forms of activators 788. Functions may be to activate a radio function or a GPS function or to move a mirror or window.

The screen image can vary according to the type of apparatus and function, but cursor 790 will in principle be movable in a Y direction over a sub-field on rotation, and by pressing on the switch the user will be able to activate functions or open sub-menus indicated by the reference numeral 794, either in that these spread out in the x direction of the main menu together with an accompanying cursor, or that the cursor moves to activate functions that are already spread across the screen. Force feedback (FF) implemented in the switch solutions will help the user to navigate better through menus and use of functions. A menu will always have a beginning and an end. Thus, the switch can be activated so that, if desired, it stops or gives resistance when an end of a menu has been reached, or a set limit for a function has been reached. Navigation in the screen image and use of functions are intended to be carried out using the multifunction switches as taught by the Applicant. Nevertheless, it is possible that a number of depression functions are removed from under the switches and arranged as independent pressure switches at the side of the rotating element. Here, given the teaching of the invention, a person of ordinary skill in the art would see that the same system could be used, but then the user would have to move his finger more and perhaps his eyes too in order to do so, which is not particularly favourable, especially when driving a car.

FIG. 43 shows a rotary switch with five pressure positions and force feedback. The switch is a variant of that previously taught and must be seen in connection with switches such as those shown in FIGS. 34-38. The operating element 924 is connected to an electromotor 926 which supplies frequencies of signals to simulate steps on rotation of the switch. The reference numeral 925 indicates a connecting part. Thus, the switch has no mechanical grooves for stepwise rotation. As described previously, it is possible here to vary the number of steps and force on the steps by varying the frequencies of the signals supplied to the motor. A tilting part 928 has construction similar to that shown in FIG. 38, but in this case it is fixed and mounted upside down. The encircling part 929 moves with a circuit board 930 and operating element 924 on tilting to the four sides for activation of the contacts 932-932′″. Between the circuit board and the tilting part is shown a spacer layer 931 which has holes 931′ for the contact springs. Central depression activates contact at contact point 933. Reference numeral 933′ indicates a contact spring. Passage of power is effected by means of sliding contacts 934 and 934′.

FIGS. 44a, 44b and 44c show a rotary switch with sliding function. FIG. 44c shows a section taken along the line XLIVc-XLIVc in FIG. 44d. When pressure is applied to the operating element 950, a centre part 951 will activate switch function by means of contact point 952 and spring 953. An intermediate part 954 is fixed in the operating element and contains a spring 956. In the same way as shown in FIG. 37, the spring will grip around a groove with steps 958 in shaft part 959 on carriage 960. On rotation there is then a stepwise movement of the operating element. The carriage 960 is movable relative to a frame 962. Two spring members 963 and 964 are immediately below the carriage at 963′ and 964′. These are biased by two wire springs 965-965′. This means that the operating element remains in a centre position when it is not actuated. A sliding contact spring 968 is fastened to the carriage and is in contact with the contact fields on the circuit board. On a sliding movement of the operating element, the movement is detected by means of the movement of the spring from 971′ to 972 or 972′. The reference numeral 973 refers to the direction of the sliding movement. As in the previously described solutions, rotation of the operating element is detected by a sliding contact spring 969 being in contact with the contact fields 971. The sliding contact spring is fastened to a rotary part 970 which in turn is fastened to the centre portion or central part 951 of the operating element. Reference numeral 974 refers to a ring which insulates contact in the centre from the rest of the contact field. As a skilled person will appreciate, force feedback systems can also be implemented for this solution. With combinations of the rotary switches described in the description above and shown in the associated drawings, the solution could also easily be adapted for an addition four press and/or tilting positions.

FIGS. 45a-45b depict a variation of the solutions shown in FIGS. 27-28. The figure shows a roller switch where the operating element 980 is movable together with the magnetic part 982 of the motor. The windings 984 are fixed in this solution. Reference numerals 986 and 987 indicate the system for detection of rotation as shown in FIG. 28. FIGS. 45a and 45b are respectively a sectional view and a plan view of the solution, whilst FIG. 45c is an exploded view of the perspective view in FIG. 45d.

FIGS. 46a-46c show a variation where connection 990 and 991 for power and outlet of signals are arranged on each side of the switch. We also see in these figures that the movable switch part is secured by a ball joint 994. This ensures movement on depression as this movement is in reality in three directions. We see how springs and contact points 996-996″ are distributed in a triangular shape. FIG. 46a is a section taken along the line XLVIa-XLVIa in FIG. 46b.

FIG. 47a shows the design of a roller switch with a force feedback system if it is desirable to have a large switch that can be operated by several fingers or a large movement of fingers. The technical structure can otherwise be as described and shown earlier. The surface of the operating element 1000 has in this case a characteristic depression in the centre 1001 and a taper 1002-1002′ on each side. This shape prevents the user from making incorrect presses. FIG. 47b shows purely schematically how the roller switch can be constructed.

FIG. 48 shows the principle for combined detection and rotating step movement for rotating switch solutions. This is an embodiment which could save parts in a rotary switch. Here, an example of use of a roller switch element 1040 is shown. Detection and step area 1041 consists of elevations 1042 which are made of or coated with an electrically conductive material. A spring-loaded metal ball 1043 rests against the area 1041. On rotation of the operating element 1040, a stepwise movement will be obtained. In addition, it will be possible to detect the rotation electronically in that, for example, every other elevation 1042 is connected to a common conductor (not shown), whilst other intermediate elevations 1042′ are connected to another common conductor (not shown). On rotation of the roller, the ball will form stepwise contact between elevations that are associated with a respective common conductor, so that contact is formed between the two conductors each time it passes between the elevations. If the ball is connected via the spring to a third terminal, it will also be possible to detect direction of rotation, as the ball in one case forms contact between the two conductors, and in another case forms contact either with elevation 1040 or 1042.

1.-142. (cancelled))

143. An operating device for controlling user functions in electronic user equipment in interaction with a display screen, and/or for controlling a means of transport, e.g., a motor vehicle, boat, ship, aircraft or the like, where the device has a control element mounted on a slide which is movable in a first or second direction along a first axis against the action of spring force, where the slide at an end point for movement is designed to cooperate with an impulse generator for simulation of an intermittent or step movement, and where the control element is provided with a plurality of pressure points for actuating switches located on the slide on tilting or depression of the control element; characterised in
that the control element is stepwise rotatable about a shaft on the slide, the stepwise position of the control element either being detectable by means of a pair of sliding contacts designed to stepwise short-circuit contact points on the slide, or being detectable by means of contact balls which alternately actuate switches that are positioned stepwise relative to the stepwise rotation of the control element. (FIGS. 2a/2b)

144. An operating device as disclosed in claim 143, characterised in
that the slide in addition is movable in a third or fourth direction in a second axial direction which forms an angle of 90° with the first axial direction and against the action of spring force, where the slide at an end point for such movement is designed to cooperate with a pulse generator for simulation of an intermittent or step movement.

145. An operating device for controlling user functions in electronic user equipment in interaction with a display screen, and/or for controlling a means of transport, e.g., a motor vehicle, boat, ship, aircraft or the like, where the device has a control element mounted on a slide which is movable in a first or second direction along a first axis against the action of spring force, where the slide at an end point for movement is designed to cooperate with an impulse generator for simulation of an intermittent or step movement, and where the control element is provided with a plurality of pressure points for actuating switches located on the slide on tilting or depression of the control element; characterised in
that the control element is stepwise rotatable about a shaft on the slide; and
that the slide in addition is movable in a third or fourth direction in a second axial direction which forms an angle of 90° with the first axial direction and against the action of spring force, where the slide at an end point for such movement is designed to cooperate with an impulse generator for simulation of an intermittent or step movement. (FIG. 2)

146. An operating device for controlling user functions in electronic user equipment in interaction with a display screen, and/or for controlling a means of transport, e.g., a motor vehicle, boat, ship, aircraft or the like, where the device has at least one control element that is rotatable relative to the device housing and which is designed on depression and/or tilting to operate various switch functions, characterised in
that stepwise positioned magnets or electromagnets are arranged on said housing, part thereof, or on a depressible carriage in the housing that is supported by switches which operate said switch functions in order on the turning or rotation of the control element to cooperate with a magnetic means on the control element to give an indication and/or detection (or determination) of the stepwise movement of the control element to give a force feedback and/or rotation. (FIG. 3)

147. An operating device for controlling user functions in electronic user equipment in interaction with a display screen, and/or for controlling a means of transport, e.g., a motor vehicle, boat, ship, aircraft or the like, where the device has a control element mounted on a slide which is stepwise movable along a first axial direction, and where the control element is provided with a plurality of pressure points for selectively actuating switches located on the operating device housing on tilting or depression of the control element, characterised in
that on its underside the control element is cross-shaped and has on each arm of the cross two switch actuating pins, so that on tilting of the control element two switches are always activated at a time by means of said pins, and on central depression of the control element at least one, but at most four switches will be activated. (FIG. 4)

148. An operating device for controlling user functions in electronic user equipment in interaction with a display screen, and/or for controlling a means of transport, e.g., a motor vehicle, boat, ship, aircraft or the like, where the device has a control element having an operating button that is stepwise rotatable about an axis and is provided with a plurality of pressure points for selectively actuating switches located on a base member in the device housing on tilting or depression of the control element, characterised in
that the control element comprises a cruciform arm structure in order on selective tilting of the control element to actuate a non-centrally located one of the switches;
that central depression of the control element is designed to activate a switch located centrally on the base member;
that the arm structure is supported by a spring means anchored to the base member; and
that the turning of the operating button is detectable by means of a sliding contact and contact point device in connection with the underside of the operating button and the upper side of the arm structure. (FIG. 5)

149. An operating device as disclosed in claim 148, characterised in
that electrical connection between the base part and the sliding contacts is provided by wiring located in the spring means.

150. An operating device for controlling user functions in electronic user equipment in interaction with a display screen, and/or for controlling a means of transport, e.g., a motor vehicle, boat, ship, aircraft or the like, where the device has a first control element made in the form of an annular body that is stepwise rotatable about a second, non-rotatable control element, where the first control element is provided with a plurality of pressure points in order on depression at a selective one thereof to actuate a switch in a first set of switches located on a base member in the device housing, and where the second control element is provided with a plurality of pressure points in order on depression or tilting at a selective one thereof to actuate a switch in a second set of switches located on a base member in the device housing, characterised in
that on its underside the second control element comprises a plurality of switch actuating pins in order on selective tilting of the control element to actuate non-centrally located one of the switches, and on central depression of the control element is to activate a switch centrally located on the base member;
that the second control element is supported by a spring means anchored to the base member; and
that the turning of the first control element is detectable by means of a sliding contact and contact point device in cooperation between the underside of the first control element and an opposite portion of the device housing. (FIG. 6)

151. An operating device for controlling user functions in electronic user equipment in interaction with a display screen, and/or for controlling a means of transport, e.g., a motor vehicle, boat, ship, aircraft or the like, where the device has a control element that is stepwise rotatable about an axis, and where the operating device control button is provided with a plurality of pressure points for selectively actuating switches located on a base part in the device housing on tilting or depression of the control element characterised in
that the control element is operatively connected to a cruciform arm structure having switch actuating pins at the ends of the arms or an annular structure having a plurality of switch actuating pins in order on selective tilting of the control element to actuate one of the switches that is non-centrally located. (FIG. 7)

152. An operating device as disclosed in claim 148, characterised in
that central depression of the control element is designed to activate a switch located centrally on the base part, an actuating pin connected to the control element operating button sliding through a central hole in the arm structure. (FIG. 7a)

153. A operating device as disclosed in claim 151, characterised in
that the turning of the operating button is detectable by means of a sliding contact and contact point device in connection with the underside of the operating button and an opposite portion of the device housing or on the base part.

154. An operating device as disclosed in claim 151, characterised in
that the operating button forms with the aid of a spring means spring engagement with an upper neck portion of the arm structure or a shoulder part of the annular structure; and
that the neck portion has a corrugated circumference for causing with the aid of the spring means stepwise turning of the operating button.

155. An operating device for controlling user functions in electronic user equipment in interaction with a display screen, and/or for controlling a means of transport, e.g., a motor vehicle, boat, ship, aircraft or the like, where the device has a roller-shaped control element that is stepwise rotatable about a shaft and is provided with a plurality of pressure points for selectively actuating switches located on a base member in the device housing on tilting or central depression of the control element, characterised in
that the control element is rotatably supported about a shaft in a cradle that is supported by three spring-equipped switches, one of the switches being on one side of the shaft and the two other switches being on the opposite side of the shaft;
that central depression of the control element is designed to activate a switch located centrally on the base member; and
that the turning of the control element is detectable by means of a sliding contact and contact point device in connection with an end member of the cradle and an end portion of the underside of the control element operating button and upper side of the arm structure. (FIG. 8; FIG. 17)

156. An operating device as disclosed in claim 155, characterised in
that the switches are selectively activatable by depression or tilting of the control element, whereby the underside of the cradle actuates the relevant switch.

157. An operating device as disclosed in claim 155, characterised in
that the shaft is supported in elongate holes in posts or side members that extend up from the base part or in the device housing.

158. An operating device as disclosed in claim 155, characterised in
that the control element is displaceable along the shaft for activating an additional switch function.

159. An operating device as disclosed in claim 155, characterised in
that the control element is curved inwards towards the shaft along a substantial part of the length of the control element.

160. An operating device as disclosed in claim 155,characterised in
that a second and a third control element respectively are hinge-connected to a respective long side of the cradle;
that a spring-loaded switch is located between the base member and the underside of the said second and third control elements in order on depression to effect a supplementary switch function. (FIG. 9)

161. An operating device for controlling user functions in electronic user equipment in interaction with a display screen, and/or for controlling a means of transport, e.g., a motor vehicle, boat, ship, aircraft or the like, where the device has a control element which is stepwise rotatable relative to the device housing, where the control element is provided with a plurality of pressure points in order on depression or tilting at a selective one thereof to actuate a switch in a set of switches, characterised by
a means for preventing rotation of the control element on said tilting or depression. (FIGS. 10-12)

162. An operating device as disclosed in claim 161, characterised in
that said means is provided by clamping wedging action relative to the device housing or a cradle/support in which the control element is rotatably arranged, or is provided by pins which form releasable engagement between the control element and said housing, cradle or support. (FIGS. 13-15)

163. An operating device for controlling user functions in electronic user equipment in interaction with a display screen, and/or for controlling a means of transport, e.g., a motor vehicle, boat, ship, aircraft or the like, where the device has a control element which is arranged on a cradle and where the control element is provided with a plurality of pressure points for selectively actuating switches located on the operating device housing or on a base member on depression or tilting of the control element characterised in
that the control element is a roller that is rotatably supported about a shaft in the cradle; and
that the rotation of the control element is detectable by means of a sliding contact and contact point device in connection with an end member of the cradle and an end portion of the control element. (FIG. 16)

164. An operating device as disclosed in claim 163, characterised in
that the switches are formed of a contact foil construction.

165. An operating device as disclosed in claim 163, characterised in
that the cradle is depressible and tiltable relative to two guide bars that extend through oval holes in the cradle, the bars being supported in oval holes in posts or members that project up from a base part or that are arranged in the device housing.

166. An operating device as disclosed in claim 163, characterised in
that the switches are selectively activatable on depression or tilting of the control element, whereby the underside of the cradle actuates the relevant switch.

167. An operating device for controlling user functions in electronic user equipment in interaction with a display screen, and/or for controlling a means of transport, e.g., a motor vehicle, boat, ship, aircraft or the like, where the device has a control element which is provided with a plurality of pressure points for selectively actuating switches located on the upper side or underside of an engagement block in the device housing on depression or tilting of the control element, characterised in
that central depression of the control element is designed to activate a switch located centrally on the upper side of the block;
that the control element is operatively connected to a cruciform arm structure in order on selective tilting of the control element to actuate non-centrally located ones of the switches; and
that downward tilting of the control element at a pressure point on one side relative to the centre of the control element is designed to activate a switch located on the underside of the block on a diametrically opposite side of said centre. (FIG. 4d)

168. An operating device as disclosed in claim 167, characterised in
that a stepwise rotatable operating button is incorporated in the control element; and
that a means is provided for detecting the rotation of the operating button.

169. An operating device for controlling user functions in electronic user equipment in interaction with a display screen, and/or for controlling a means of transport, e.g., a motor vehicle, boat, ship, aircraft or the like, where the device has a control element provided with a plurality of pressure points for selectively actuating switches located on the operating device housing or on a base member in the housing on depression or tilting of the control element, characterised in
that on its underside the control element is cruciform and has on each arm of the cross two switch actuating pins, so that on tilting or central depression of the control element two switches are always activated at a time by means of said pins. (FIG. 4a-c)

170. An operating device as disclosed in claim 169, characterised in
that a stepwise rotatable operating button is incorporated in the control element; and
that a means is provided for detecting rotation of the operating button.

171. An operating device as disclosed in claim 169, characterised in
that the switches are formed of a contact foil construction.

172. An operating device as disclosed in claim 147, characterised in
that the control element is depressible and tiltable in four directions relative to two guide bars that extend through oval holes in the control element and are arranged in the device housing.

173. An operating device for controlling user functions in electronic user equipment in interaction with a display screen, and/or for controlling a means of transport, e.g., a motor vehicle, boat, ship, aircraft or the like, where the device has a control element which is provided with a plurality of pressure points for selectively actuating switches located on the operating device housing or on a base member in the housing on depression or tilting of the control element, characterised in
that the control element cooperates with or forms a part of a step motor; and
that the step motor is designed to carry out operations selected from the group: controlling the number of steps, controlling the distance between steps, controlling the force a user needs to apply, braking or stopping movement of the control element, causing a back or return movement, stimulating or oscillating (small reciprocating motions), detecting movement and direction of movement. (FIGS. 18-19; FIGS. 20-26)

174. An operating device as disclosed in claim 173, characterised in
that the step motor casing forms a part of the control element; and
that the step motor shaft is designed to be kept stationary.

175. An operating device as disclosed in claim 173, characterised in
that the step motor shaft is connected to the control element; and
that the step motor casing is arranged to be stationary.

176. An operating device as disclosed in claim 173, characterised in
that a rotation detector is mounted in association with the step motor to detect mutual rotation between the motor casing and the shaft.

177. An operating device for controlling user functions in electronic user equipment in interaction with a display screen, and/or for controlling a means of transport, e.g., a motor vehicle, boat, ship aircraft or the like, where the device has a control element provided with a plurality of pressure points for selectively actuating switches located on the operating device housing or on a base member in the housing on depression and/or tilting of the control element, characterised in
that the control element is a stepwise rotatable operating button or disc which has a diameter d in millimetres, and where the number of steps the operating button/disc can be turned is n;
that a constant k ε [d/n)]; and
that k=1.7-2.4 mm per number of steps. (FIG. 7c]

178. An operating device for controlling user functions in electronic user equipment in interaction with a display screen, and/or for controlling a means of transport, e.g., a motor vehicle, boat, ship, aircraft or the like, where the device has a control element provided with a plurality of pressure points for selectively actuating switches located on the operating device housing or on a base member in the housing on depression and/or tilting of the control element, characterised in
that the control element is a stepwise rotatable roller or drum which has a largest diameter d in millimetres, and where the number of steps the roller or drum can be turned is n;
that a constant k ε [d/n)]; and
that k=1.5-2.0 mm per number of steps. (FIG. 9c]

179. An operating device for controlling user functions in electronic user equipment in interaction with a display screen, and/or for controlling a means of transport, e.g., a motor vehicle, boat, ship, aircraft or the like, where the device has a means for force feedback, characterised in
that the operating device has a roller-shaped, rotatable control element, where rotation of the control element is detectable and where the control element consists of an outer part of a DC electromotor or step motor installed inside the operating device, where the motor is designed on controlled power supply to give on manually actuated rotation of the control element a counterforce selected from the group: pulsed counterforce adapted to the gradual rotation of the control element, steady counterforce, gradually increasing counterforce, gradually decreasing counterforce. (FIG. 27; FIG. 28; FIG. 45)

180. An operating device for controlling user functions in electronic user equipment in interaction with a display screen, and/or for controlling a means of transport, e.g., a motor vehicle, boat, ship, aircraft or the like, where the device has a means for force feedback, characterised in
that the operating device has a roller-shaped, rotatable control element, where rotation of the control element is detectable, where the control element forms operative engagement with a DC electromotor or step motor by means of mechanical transmission to an internal end portion of the control element or the the control element shaft, where the motor is designed on controlled power supply to give on manually actuated rotation of the control element a counterforce selected from the group: pulsed counterforce adapted to the gradual rotation of the control element, steady counterforce, gradually increasing counterforce, gradually decreasing counterforce. (FIGS. 30a-30d; FIGS. 31a-33b)

181. An operating device as disclosed in claim 179, characterised in
that the mechanical transmission between the motor and the internal end portion of the control element is via a gearwheel/gear rim engagement. (FIGS. 30a-30d)

182. An operating device as disclosed in claim 180, characterised in
that the mechanical transmission between the motor and the control element shaft is selected from the group: a Bowden cable connection, a wire connection, a connecting element of a flexible material or structure, a universal joint connection, a gearwheel connection, a belt drive, a toothed belt drive. (FIGS. 31 a-33b)

183. An operating device as disclosed in claim 179, characterised in
that rotation of the control element is detectable by means of a device selected from the group: a Hall sensor; a resistance measuring device current; contact field sliders; an optical detector in cooperation with a rotatable disc provided with an optically readable pattern; a magnetic field detector in cooperation with a magnetically coded, rotatable disc; a light detector in cooperation with a rotatable, stepwise perforated disc. (FIGS. 29a-29f)

184. An operating device as disclosed in claims 179 or 180, characterised in
that the control element is supported in a cradle or support and for actuation of a respective switch function is depressible at a centre portion and/or at respective ends. (FIGS. 28g-28i)

185. An operating device as disclosed in claims 179 or 180, characterised in
that the control element is designed to form operative cooperation with two or four switches arranged externally in relation to the operating device for operating a respective operative switch function. (FIGS. 28j-28u)

186. An operating device as disclosed in claim 185, characterised in
that one external switch is provided at each axial end area of the operating device and/or one external switch on opposite long sides of the operating device.

187. An operating device for controlling user functions in electronic user equipment in interaction with a display screen, and/or for controlling a means of transport, e.g., a motor vehicle, boat, ship, aircraft or the like, where the device has a means for force feedback, characterised in
that the operating device has a button-like, rotatable control element having four or five depression points or a central depression point and four-way tilting for selective actuation of a respective operative switch function;
that the control element forms operative engagement with a DC electromotor or step motor by means of mechanical transmission to a peripheral portion or a central portion of the control element, where the motor is designed on controlled power supply to give on manually actuated rotation of the control element a counterforce selected from the group: pulsed counterforce adapted to the gradual rotation of the control element, steady counterforce, gradually increasing counterforce, gradually decreasing counterforce. (FIGS. 34a-34c; 35a-35c)

188. An operating device as disclosed in claim 187, characterised in
that the mechanical transmission between the motor and said peripheral portion in by gearwheel engagement with a toothed periphery of the control element or by belt drive. (FIGS. 34a-34c)

189. An operating device as disclosed in claim 187, characterised in
that the mechanical transmission to the central portion of the control element is via a ball joint having engagement pins. (FIG. 35a-35c)

190. An operating device as disclosed in claim 187, characterised in
that rotation of the control element is detectable, e.g., by means of contact field sliders in association with the control element or via manually actuated rotation of the motor.

191. An operating device for controlling user functions in electronic user equipment in interaction with a display screen, and/or for controlling a means of transport, e.g., a motor vehicle, boat, ship, aircraft or the like, characterised in
that the operating device has a uniform, button-like, rotatable control element having one central depression point, and in a peripheral portion four depression points or the possibility of four-way tilting for selective actuation of a respective operative switch function;
that the control element is designed for stepwise rotation that is detectable by means of a rotation detector, e.g., made in the form of current contact field sliders;
that the control element is designed when depressed to activate via a central rotatable stem a centrally located switch; and
that a spider or an arm-provided block is arranged non-rotatably, but is slidable in relation to said stem in order on tilting or depression of the control element at the peripheral portion to tilt for actuation of a respective switch arranged in the peripheral portion of the operating device. (FIGS. 36-38c)

192. An operating device according to claim 191, characterised in
that the rotation detector seen radially is in an area between the central switch and the four switches in the peripheral portion of the operating device. (FIGS. 36; 37a-37d)

193. An operating device as disclosed in claim 191, characterised in
that the rotation detector seen radially is in an area beyond the four switches at the peripheral portion of the operating device. (FIGS. 38a-38c)

194. An operating device as disclosed in claim 191, characterised in
that the four switches at the peripheral portion of the operating device are in a first plane; and
that the centrally located switch and the rotation detector are in a second plane. (FIGS. 36; 37a-37d)

195. An operating device as disclosed in claim 191, characterised in
that the four switches in the peripheral portion of the operating device, the centrally located switch and the rotation detector are in the same plane. (FIGS. 36-38c)

196. An operating device as disclosed in claim 191, characterised in
that the control element is mounted so as to be stepwise rotatable about a non-rotatable frame part, the control element having a rotatable tilting and pressure part which supports a spring forming yielding engagement with a polygonal element on the frame part for marked stepwise movement of the control element. (FIGS. 37a-37d)

197. An operating device as disclosed in claim 191, characterised in
that the arm-provided block has a polygonal peripheral portion that forms yielding engagement with a spring located on a rotary part on which the control element is fastened for marked stepwise movement of the control element. (FIGS. 38a-38c)

198. An operating device as disclosed in claim 191, characterised in
that the central stem is designed to be depressed against the action of an elastic, compressible element. (FIG. 37c)

199. An operating device as disclosed in claim 191, characterised in
that the control element forms operative engagement with a DC electromotor or step motor by means of a mechanical transmission from the motor to a central portion of the control element;
that the motor is designed on controlled power supply to give on manually actuated rotation of the control element a counterforce (force feedback) selected from the group: pulsed counterforce adapted to the gradual rotation of the control element, steady counterforce, gradually increasing counterforce, gradually decreasing counterforce; and
that the centrally located switch has for provision of the mechanical transmission a central perforation for the lead-through of a motor shaft extension for rotational engagement with a wholly or partly axially extending opening in the central stem, the motor shaft extension preferably being made of an elastically yielding material or is tiltably or articulately connected to the motor shaft. (FIG. 36)

200. An operating device for controlling user functions in electronic user equipment in interaction with a display screen, and/or for controlling a means of transport, e.g., a motor vehicle, boat, ship, aircraft or the like, where the operating device has a first, stepwise rotatable control element which encircles a second, non-rotatable, centre position deviation movable control element, where the first control element is designed on depression or tilting to actuate a respective switch of four switches located in the peripheral area of the operating device, where a rotation detector is provided for detecting the stepwise rotation of the first control element, and where the second switch on centre position deviation is designed to actuate a centre position deviation detector, characterised in
that the second control element on central depression is in addition designed to actuate a centrally located switch;
that the central switch and the four switches in the peripheral area of the operating device are located in a same, first plane;
that the centre position deviation detector is located in a second plane below and parallel to the first plane; and
that the central switch has a central opening for passage of a pin which forms a connection between an operating button on the second control element and the centre position deviation detector. (FIGS. 39a-39d)

201. A operating device as disclosed in claim 200, characterised in
that the centre position deviation detector consists of a set of strain gauges arranged in a cross shape on a fixed, thin disc, and where said pin is anchored in the disc at the centre of the set of strain gauges. (FIGS. 39a-39d)

202. An operating device as disclosed in claim 200, characterised in
that the rotation detector is of a type based on current contact field and current contact field sliders. (FIG. 39d)

203. An operating device as disclosed in claim 200, characterised in
that the rotation detector seen radially is located in an area between the central switch and the four switches in the peripheral portion of the operating device. (FIG. 39d)

204. An operating device as disclosed in claim 200, characterised in
that the four switches in the peripheral portion of the operating device, the centrally located switch and the rotation detector are in the same plane. (FIG. 39d)

205. An operating device as disclosed in claims 179, 180, or 187, characterised in
that the roller-shaped control element in connection with its surface has a capacative sensor for initiating a switch function in order to cut in or cut out power supply to the motor in connection with a power saving function. (FIG. 40a)

206. An operating device as disclosed in claims 179, 180, or 187, characterised in
that the roller-shaped control element is designed to cooperate with an optical detector which in the presence or absence of a user's finger close to or on the surface of the control element is designed to initiate a switch function in order to switch on and switch off power supply to the motor in connection with a power saving function. (FIG. 40b)

207. An operating device as disclosed in claim 179, characterised in
that the roller-shaped control element is designed to cooperate with a braking mechanism or a locking mechanism located at an end area of the control element, for locking the control element against rotation when it is not in use or during navigation in a menu. (FIG. 41)

208. An operating device for controlling user functions in electronic user equipment in interaction with a display screen, and/or for controlling a means of transport, e.g., a motor vehicle, boat, ship, aircraft or the like, characterised in
that the operating device has a uniform, button-like control element having one central depression point, and in a peripheral portion four depression points or the possibility for four-way tilting for selective actuation of a respective operative switch function;
that the control element is designed to activate via a central stem a centrally located switch when depressed; and
that a spider or arm-provided block is arranged in slidable relation to said stem in order on tilting or depression of the control element in a peripheral portion to tilt for actuation of a respective switch arranged in the edge portion of the operating device. (FIGS. 34a, 38)

209. An operating device for controlling user functions in electronic user equipment in interaction with a display screen, and/or for controlling a means of transport, e.g., a motor vehicle, boat, ship, aircraft or the like, where the operating device has a control element that is designed on depression and/or tilting to operate a respective switch function of various switch functions, where the switch functions are provided by contact foil portions on the device housing, arms being connected to the control element operating button in order on activation thereof via the arms and catch springs to actuate a respective contact foil portion via ends on a spider, the control element being designed to operate a selective one of four switch functions, characterised in
that there is provided in an additional, fifth possible switch function, wherein the control element against the action of a catch spring is centrally depressible in order via a pin that is movable through a block connecting the arms and a hole through the centre of the spider to actuate a switch function related to a respective contact foil portion.

210. An operating device for controlling user functions in electronic user equipment in interaction with a display screen, and/or for controlling a means of transport, e.g., a motor vehicle, boat, ship, aircraft or the like, where the operating device has a uniform button-like, rotatable control element having one central depression point, and in a peripheral portion four depression points or the possibility for four-way tilting for selective actuation of a respective, operative switch function, and where the control element is designed via a central stud on depression to activate a centrally located switch, characterised in
that a spider or arm-provided block is arranged to be stationary relative to a switch-provided circuit board that is tiltable when the control element is tilted, whereby the spider or block in cooperation with the circuit board actuates a respective switch on the circuit board:
that the operating device has a means for force feedback;
that the rotational movement of the control element is actuated by an electromotor or step motor for initiating and simulating a “step feeling”;
that the angular extent and speed of the rotational movement are measurable; and
that the “step feeling” generated by the motor due to actuated rotation is variable in frequency. (FIG. 43)

211. An operating device for controlling user functions in electronic user equipment in interaction with a display screen, and/or for controlling a means of transport, e.g., a motor vehicle, boat, ship, aircraft or the like, where the device has a control element located on a slide that is movable in a first or second direction relative to a central position along a first axis against the action of spring force, and where the control element is on depression thereof designed to actuate switches located on the slide, characterised in
that the control element is stepwise rotatable about a shaft on the slide, the stepwise position of the control element either being detectable by means of a pair of sliding contacts designed to stepwise short-circuit contact points on the slide, or being detectable by means of contact balls which alternately actuate switches that are positioned stepwise related to the stepwise rotation of the control element. (FIG. 44)

212. An operating device as disclosed in claim 211, characterised in
that the slide at an end point for movement is designed to cooperate with an impulse generator for simulation of an intermittent or step movement.

213. An operating device as disclosed in claim 211, characterised in
that the control element in addition has a tilting function in order on depression or tilting in a peripheral area to actuate respective switches located on the slide.

214. An operating device as disclosed in claim 211, characterised in
that the operating device has a means for force feedback;
that the stepwise rotational movement of the control element is actuated by an electromotor or a step motor for initiating and simulating a “step feeling”;
that the angular extent and speed of the rotational movement are measurable; and
that the “step feeling” generated by the motor due to actuated rotation is variable in frequency.

215. An operating device as disclosed in claim 179, characterised in
that the operating device control element is movable together with the magnetic part of the motor; and
that the winding part of the motor is arranged so as to be stationary in the operating device. (FIG. 45)

216. An operating device as disclosed in claim 179, characterised in
that the operative device control element is movable with the winding part of the motor; and
that the magnetic part of the motor is arranged so as to be stationary in the operating device. (FIG. 27; FIG. 28)

217. An operating device as disclosed in claims 155, 163, or 179, characterised in
that the cradle in which the operating device control element is supported is connected to the operating device base member via a ball joint connection. (FIG. 45; FIG. 46)

218. An operating device as disclosed in claims 155, 163, or 179, characterised in
that the motor has terminals for power and movement-related signals at respective axial end areas. (FIG. 46)

219. An operating device as disclosed in claims 155, 163, or 179, characterised in
that the control element has an axial length that exceeds the axial length of the motor;
that the control element at a central portion has a circumferential depression; and
that the parts of the control element that extend from the central portion towards respective ends of the control element have a gradually decreasing diameter. (FIG. 47)

220. An operating device for controlling user functions in electronic user equipment in interaction with a display screen, and/or for controlling a means of transport, e.g., a motor vehicle, boat, ship, aircraft or the like, where the device has a control element in the form of a controllable roller or drum or where the control element has an endless belt running around two spaced-apart rollers in a support, and where the control element is provided with a plurality of pressure points for selectively actuating switches located on the operating device housing or on a base member in the housing on tilting and/or depression of the control element characterised in
in that an end area of the control element has a plurality of electrically conducting, radially extending elevations;
that every other elevation is connected to a first terminal;
that the other elevations are connected to a second terminal; and
that there is provided a spring-loaded, electrically conducting ball resting against the end area, so that it successively on the stepwise movement of the control element forms contact with successive pairs of elevations, where the elevations in the pair have respective contact with said first and second terminal, whereby the stepwise movement is electrically registrable. (FIG. 48)

221. An operating device as disclosed in claim 143, characterised in
that the operating device has a means for force feedback;
that the number of stepwise rotational movements or stepwise sliding movements given through the system by force feedback is limited by functions that are available, and as shown on the screen in an interactive system;
that the magnitude of available movement is controlled by using force feedback dependent upon available functions;
that the magnitude of frequencies for initiating and simulating a “step feeling” is contingent upon the number of functions, available data and force applied to the operating element. (FIG. 42)
